(19) United States
(12) Patent Application Publication
(10) Pub. No.: US 2024/0201921 A1
(43) Pub. Date: Jun. 20, 2024

(54) INFORMATION PROCESSING APPARATUS, INFORMATION PROCESSING METHOD, RADIATION IMAGING SYSTEM, AND STORAGE MEDIUM

(71) Applicant: CANON KABUSHIKI KAISHA, Tokyo (JP)

(72) Inventor: MASAYA KAWAI, Kanagawa (JP)

(21) Appl. No.: 18/539,004

(22) Filed: Dec. 13, 2023

(30) Foreign Application Priority Data
Dec. 16, 2022 (JP) 2022-201194

(51) Int. Cl. G06F 3/14

(52) U.S. Cl. CPC G06F 3/14

(57) ABSTRACT

An information processing apparatus includes an obtaining unit for obtaining processing information obtained by an external processing apparatus processing a radiation image from the external processing apparatus, and a control unit for performing control to, according to a type of a processing content in the processing information, determine whether to immediately display the processing information on a display unit, or after the obtaining unit obtains a plurality of pieces of the processing information in which the processing content is of a same type, display the plurality of pieces of the processing information on the display unit.

### BACKGROUND OF THE DISCLOSURE

### Field of the Disclosure

The present disclosure relates to an information processing apparatus, an information processing method, a radiation imaging system, and a storage medium.

### Description of the Related Art

A radiation imaging apparatus and a radiation imaging system including the radiation imaging apparatus are known. The radiation imaging apparatus emits radiation to a subject, detects the intensity distribution of the radiation passing through the subject, and captures a radiation image of the subject. In an inspection using radiation (a radiation inspection), a doctor in each specialty typically sets inspection information including an imaging target part of a subject and an imaging method. Radiation imaging is then executed based on the set inspection information using the radiation imaging apparatus.

In recent years, artificial intelligence (AI) technology advances for medical image diagnosis support. Japanese Patent Application Laid-Open No. 2021-58272 discusses a technique for performing an abnormality detection process on a diagnosis image using a machine learning algorithm, such as deep learning, as AI technology. On the radiation imaging apparatus, an image processing system for diagnosis support can be mounted. Using an external image processing system outside the radiation imaging apparatus, it is possible to obtain support more useful for a user such as a doctor. In this case, the radiation imaging apparatus can cooperate with an external processing apparatus serving as the external image processing system to transmit and receive a radiation image as an original image and a processed image after the radiation image is processed to and from each other, and can provide a processed image subjected to processing that is not mounted on the radiation imaging apparatus for a diagnosis. Japanese Patent Application Laid-Open No. 2012-223 discusses a technique in which a plurality of processing apparatuses connected to a network performs image processing on a medical image by using distributed processing.

### SUMMARY OF THE DISCLOSURE

According to an aspect of the present disclosure, a radiation imaging apparatus includes an obtaining unit configured to obtain processing information obtained by an external processing apparatus processing a radiation image from the external processing apparatus, and a control unit configured to perform control to, according to a type of a processing content in the processing information, determine whether to immediately display the processing information on a display unit, or after the obtaining unit obtains a plurality of pieces of the processing information in which the processing content is of the same type, display the plurality of pieces of the processing information on the display unit.

Further features of the present disclosure will become apparent from the following description of exemplary embodiments with reference to the attached drawings.

### BRIEF DESCRIPTION OF THE DRAWINGS

FIG. 1 is a diagram illustrating an example of a schematic configuration of a radiation imaging system according to a first exemplary embodiment of the present disclosure.

FIG. 2 is a diagram illustrating an example of a schematic configuration of an overall control unit illustrated in FIG. 1.

FIGS. 3A and 3B are diagrams illustrating examples of an imaging method table and an external processing table stored in a storage unit illustrated in FIG. 2.

FIG. 4 is a diagram illustrating the first exemplary embodiment of the present disclosure and illustrating an example of an image table that stores image information regarding a radiation image obtained by a radiation imaging apparatus illustrated in FIG. 1 and processing information (which can include an externally processed image) obtained by each external processing apparatus illustrated in FIG. 1.

FIG. 5-1 is a diagram illustrating an example of a new inspection input screen displayed on a display unit illustrated in FIG. 1.

FIG. 5-2 is a diagram illustrating an example of a new inspection input screen displayed on a display unit illustrated in FIG. 1.

FIG. 5-3 is a diagram illustrating an example of an imaging information input screen displayed on the display unit illustrated in FIG. 1.

FIG. 6 is a diagram illustrating an example of an imaging screen displayed on the display unit illustrated in FIG. 1.

FIG. 7 is a flowchart illustrating an example of a processing procedure in a control method for controlling the radiation imaging apparatus according to the first exemplary embodiment of the present disclosure.

FIG. 8 is a flowchart illustrating an example of a processing procedure in the control method for controlling the radiation imaging apparatus according to the first exemplary embodiment of the present disclosure.

FIG. 9 is a flowchart illustrating an example of a processing procedure in the control method for controlling the radiation imaging apparatus according to the first exemplary embodiment of the present disclosure.

FIG. 10 is a flowchart illustrating an example of a processing procedure in the control method for controlling the radiation imaging apparatus according to the first exemplary embodiment of the present disclosure.

FIG. 11 is a flowchart illustrating an example of a processing procedure in the control method for controlling the radiation imaging apparatus according to the first exemplary embodiment of the present disclosure.

FIG. 12 is a flowchart illustrating an example of a processing procedure in a control method for controlling a radiation imaging apparatus according to a second exemplary embodiment of the present disclosure.

FIG. 13 is a diagram illustrating the second exemplary embodiment of the present disclosure and illustrating an example of an image table that stores image information regarding a radiation image obtained by the radiation imaging apparatus illustrated in FIG. 1 and processing information (which can include an externally processed image) obtained by each external processing apparatus illustrated in FIG. 1.

FIG. 14 is a flowchart illustrating an example of a processing procedure in a control method for controlling the radiation imaging apparatus according to the second exemplary embodiment of the present disclosure.

FIG. 15 is a flowchart illustrating an example of a processing procedure in the control method for controlling the radiation imaging apparatus according to the second exemplary embodiment of the present disclosure.

FIG. 16 is a flowchart illustrating an example of a processing procedure in the control method for controlling the radiation imaging apparatus according to the second exemplary embodiment of the present disclosure.

FIG. 17 is a flowchart illustrating an example of a processing procedure in the control method for controlling the radiation imaging apparatus according to the second exemplary embodiment of the present disclosure.

### DESCRIPTION OF THE EMBODIMENTS

With reference to the drawings, embodiments (exemplary embodiments) for carrying out the present disclosure will be described below.

A first exemplary embodiment will now be described.

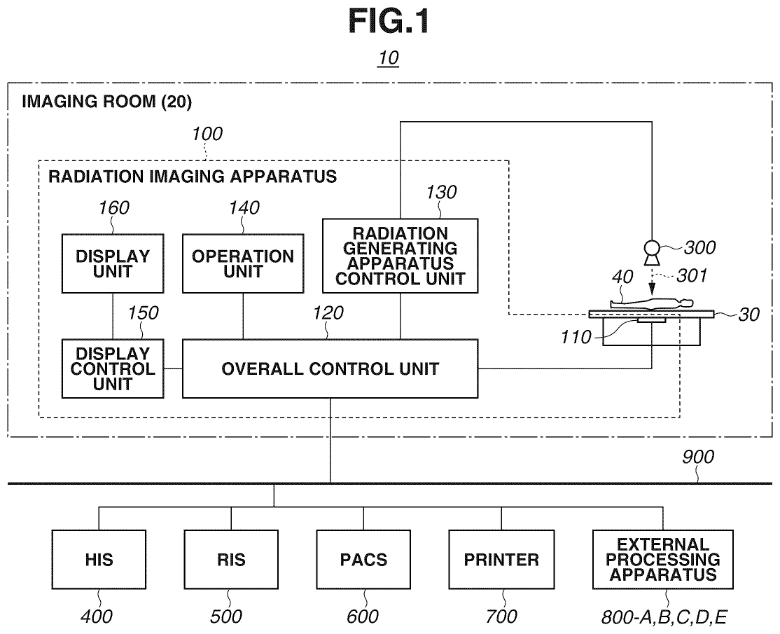

FIG. 1 is a diagram illustrating an example of a schematic configuration of a radiation imaging system 10 according to the first exemplary embodiment of the present disclosure. The radiation imaging system 10 includes a radiation imaging apparatus 100, a radiation generating apparatus 300, a hospital information system (HIS) 400, a radiology information system (RIS) 500, a picture archiving and communication system (PACS) 600, a printer 700, external processing apparatuses 800-A to 800-E, and a network 900. In an imaging room 20, the radiation imaging apparatus 100, the radiation generating apparatus 300, and an imaging table 30 are installed. The radiation imaging apparatus 100 includes a radiation detection unit 110, an overall control unit 120, a radiation generating apparatus control unit 130, an operation unit 140, a display control unit 150, and a display unit 160.

The radiation generating apparatus 300 emits radiation 301 toward a subject 40 placed on the imaging table 30 (e.g., a particular part of the subject 40) and the radiation detection unit 110 based on control of the radiation generating apparatus control unit 130. The radiation generating apparatus 300 functions as a radiation source that generates the radiation 301, and includes, for example, a radiation tubular lamp. The radiation generating apparatus 300 can emit the radiation 301 into a desired emission range. On an emission surface of the radiation generating apparatus 300, a diaphragm (not illustrated) for blocking the radiation 301 is installed. A user can adjust the emission range of the radiation 301 emitted from the radiation generating apparatus 300 by controlling the diaphragm.

The radiation imaging apparatus 100 is an apparatus for performing radiation imaging of the subject 40. The radiation imaging apparatus 100 is communicably connected to the HIS 400, the RIS 500, the PACS 600, the printer 700, and the external processing apparatuses 800-A to 800-E via the network 900.

The radiation detection unit 110 is a detection unit for detecting the radiation 301 that has passed through the subject 40 and generating a radiation image (radiation image data according to the radiation 301). Specifically, the radiation detection unit 110 detects the radiation 301 having passed through the subject 40 as an electric signal (a charge) corresponding to the amount of transmitted radiation. For example, the radiation detection unit 110 is composed of a direct conversion sensor made of amorphous selenium (a-Se) or the like that directly converts the radiation 301 into an electric signal (a charge) or an indirect-type sensor that uses a scintillator made of cesium iodide (CsI) and a photoelectric conversion element made of amorphous silicon (a-Si) and the like is used. The radiation detection unit 110 then performs analog-to-digital (A/D) conversion on the detected electric signal (charge) to generate radiation image data and store the radiation image data in a storage unit (not illustrated).

The radiation detection unit 110 can assign image information (e.g., an image identifier (ID), the imaging date and time, and the transfer status of the image data) to the radiation image data and transfer the image information with the radiation image data to the overall control unit 120.

The overall control unit 120 performs overall control of the operation of the radiation imaging apparatus 100 and also performs various processes based on, for example, an operation input on the operation unit 140. The overall control unit 120 is connected to the radiation detection unit 110 via, for example, a wireless local area network (LAN). The overall control unit 120 and the radiation detection unit 110 transmit and receive radiation image data and a control signal to and from each other. That is, radiation image data stored in the radiation detection unit 110 after radiation imaging is output (transferred) to the overall control unit 120 via the wireless LAN. The overall control unit 120 has an application function that operates on a computer. For example, the overall control unit 120 controls the operation of the radiation detection unit 110 and also outputs images including a radiation image to the display unit 160 or outputs a graphical user interface (GUI) to the display unit 160, via the display control unit 150.

The radiation generating apparatus control unit 130 sets imaging conditions for the radiation 301 in the radiation generating apparatus 300 and controls the radiation generating apparatus 300 based on control of the overall control unit 120.

The operation unit 140 inputs, for example, an operation input from the user to the overall control unit 120.

The operation unit 140 is composed of, for example, a mouse and an operation button. The operation unit 140 inputs various instructions from the user to the overall control unit 120.

The display control unit 150 controls the display unit 160 based on control of the overall control unit 120.

The display unit 160 displays various images and various pieces of information, based on control of the display control unit 150. The display unit 160 is achieved by, for example, a liquid crystal display. The display unit 160 displays various images and various pieces of information to the user (e.g., a photographer or a doctor). The display unit 160 and the operation unit 140 can be achieved as a touch panel in which the display unit 160 and the operation unit 140 are integrated together.

The HIS 400 is a hospital information system including a server for managing the progress of an inspection and accounting information. In a case where radiation imaging is performed, the user inputs an inspection instruction through a terminal (input unit) of the HIS 400. The HIS 400 then transmits request information to the radiology department of the hospital as the request destination of the radiation imaging. This request information is referred to as an “inspection order”. The inspection order includes the department name of the request source, an inspection ID, an inspection item, and patient information as an example of subject information regarding the subject 40. Execution information (an image ID and the imaging date and time) regarding an inspection executed by the radiation imaging apparatus 100 is transmitted to the HIS 400. The execution information transmitted to the HIS 400 is used to manage the progress of the inspection and is also used in an accounting process after the inspection.

The RIS 500 is a radiology information system for transmitting, for example, an inspection order to the radiation imaging apparatus 100. When the RIS 500 receives an inspection order, the radiology department of the hospital serving as the request destination of radiation imaging adds imaging information regarding the radiation imaging (e.g., imaging target part information, imaging direction information, and manipulation information) as an imaging protocol to the inspection order and transmits the inspection order to the radiation imaging apparatus 100. The radiation imaging apparatus 100 then executes the radiation imaging according to the received inspection order. The radiation imaging apparatus 100 acquires (obtains) a radiation image of the subject 40 through the radiation imaging, generates inspection information in which the radiation image and the inspection order are associated together, and outputs the inspection information with the radiation image.

The PACS 600 is an image saving communication system (an image saving apparatus) for managing various images including a radiation image. For example, the PACS 600 is a server mainly intended to image management. Using a high-definition monitor connected to the PACS 600, the work of examining radiation images, detailed post-processing, and diagnosis work are executed. As described above, a radiation image acquired by the radiation imaging apparatus 100 is transmitted to the PACS 600.

The printer 700 performs print output of various images including a radiation image and various pieces of information.

Each external processing apparatus 800 generates processing information by processing (performing image processing on) a radiation image obtained by the radiation imaging apparatus 100 performing radiation imaging. Each external processing apparatus 800 is an external image processing system outside the radiation imaging apparatus 100. At this time, the processing information includes at least one piece of information among information regarding an externally processed image, overlay information, report information, and rejection information. The externally processed image is obtained by the external processing apparatus 800 processing (performing the image processing on) the radiation image obtained by the radiation imaging apparatus 100. At this time, the overlay information, the report information, and the rejection information are image-related information related to the radiation image obtained by the radiation imaging apparatus 100. The external processing apparatus 800 then transmits the generated processing information to the radiation imaging apparatus 100 (and further, the PACS 600 and the like). The radiation imaging apparatus 100 presents the processing information received from the external processing apparatus 800 with the original radiation image and provides processing that is not mounted on the radiation imaging apparatus 100. In the present exemplary embodiment, the external processing apparatus 800 performs diagnosis support processing and imaging support processing using artificial intelligence (AI) technology. In the example illustrated in FIG. 1, five external processing apparatuses 800-A, 800-B, 800-C, 800-D, and 800-E are provided as the external processing apparatus 800. In the following description, the external processing apparatus 800-A is referred to as an “external processing system A”, the external processing apparatus 800-B is referred to as an “external processing system B”, and the external processing apparatus 800-C is referred to as an “external processing system C”, where necessary. Similarly, in the following description, the external processing apparatus 800-D is referred to as an “external processing system D”, and the external processing apparatus 800-E is referred to as an “external processing system E”, where necessary. In the following description, descriptions common to the external processing apparatuses 800-A to 800-E are given by referring to the external processing apparatuses 800-A to 800-E simply as an “external processing apparatus 800”, where necessary.

The network 900 connects the radiation imaging apparatus 100, the HIS 400, the RIS 500, the PACS 600, the printer 700, and the external processing apparatuses 800-A to 800-E so that these apparatuses can communicate with each other. The network 900 is composed of, for example, a LAN or a wide area network (WAN). Each external processing apparatus 800 may not need to be an apparatus physically separate from the radiation imaging apparatus 100, and may be composed of another computer different from that of the radiation imaging apparatus 100 and virtualized in the same apparatus as the radiation imaging apparatus 100. Alternatively, for example, a virtualized computer composing each external processing apparatus 800 can be present on a cloud.

Each of the apparatuses 100 and 300 to 800 includes one or more computers. In each computer, for example, a main control unit such as a central processing unit (CPU) and storage units such as a read-only memory (ROM) and a random-access memory (RAM) are provided. In each computer, a communication unit such as a network card and input/output units such as a keyboard, a display, and a touch panel can also be provided. These component units are electrically connected together by a bus and controlled by the main control unit executing programs stored in the storage units.

The configuration illustrated in FIG. 1 is merely an example and can be appropriately changed. For example, the various apparatuses (400 to 800) are connected to the radiation imaging apparatus 100 via the network 900 so that the various apparatuses (400 to 800) can communicate with the radiation imaging apparatus 100 in FIG. 1. However, the present exemplary embodiment is not limited to the configuration illustrated in FIG. 1. For example, a configuration can be employed in which a radiation image obtained by the radiation imaging apparatus 100 is stored in a portable storage medium, such as a digital versatile disc (DVD) and input to the various apparatuses (400 to 800) via the portable storage medium. The network 900 can be composed of a wired network, or a part of the network 900 can be composed of a wireless signal transmission path.

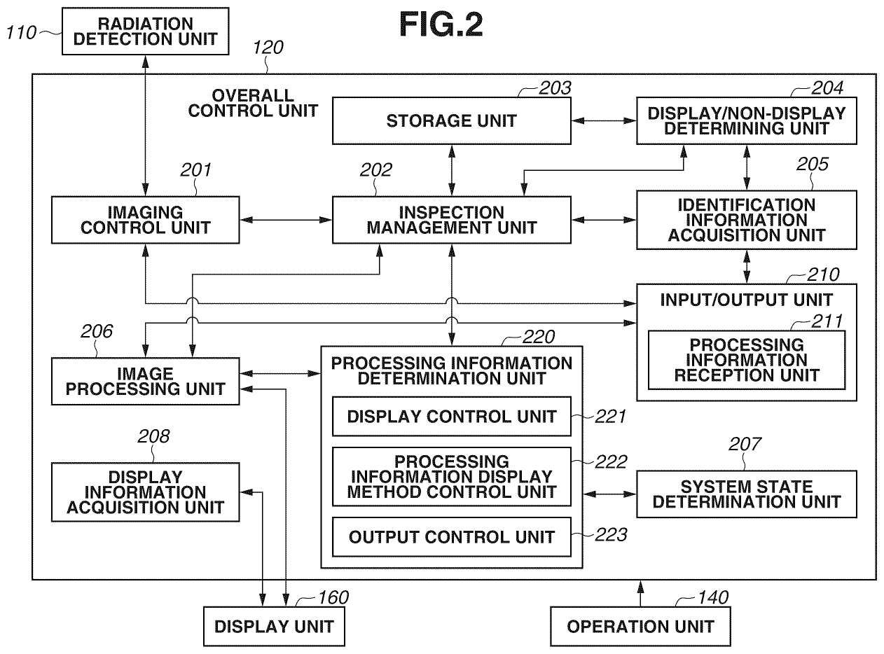

FIG. 2 is a diagram illustrating an example of the schematic configuration of the overall control unit 120 illustrated in FIG. 1. In FIG. 2, components similar to the components illustrated in FIG. 1 are designated by the same signs, and are not described in detail.

The overall control unit 120 includes an imaging control unit 201, an inspection management unit 202, a storage unit 203, a display/non-display determining unit 204, an identification information acquisition unit 205, an image processing unit 206, a system state determination unit 207, a display information acquisition unit 208, an input/output unit 210, and a processing information determination unit 220.

The imaging control unit 201 controls radiation imaging in the radiation detection unit 110. The imaging control unit 201 transmits to the radiation detection unit 110 a transfer request signal requesting the radiation detection unit 110 to transfer a radiation image, and receives the radiation image from the radiation detection unit 110. The imaging control unit 201 manages the received radiation image with radiation detection unit information regarding the radiation detection unit 110. The radiation image is further associated with inspection information and an imaging protocol managed by the inspection management unit 202.

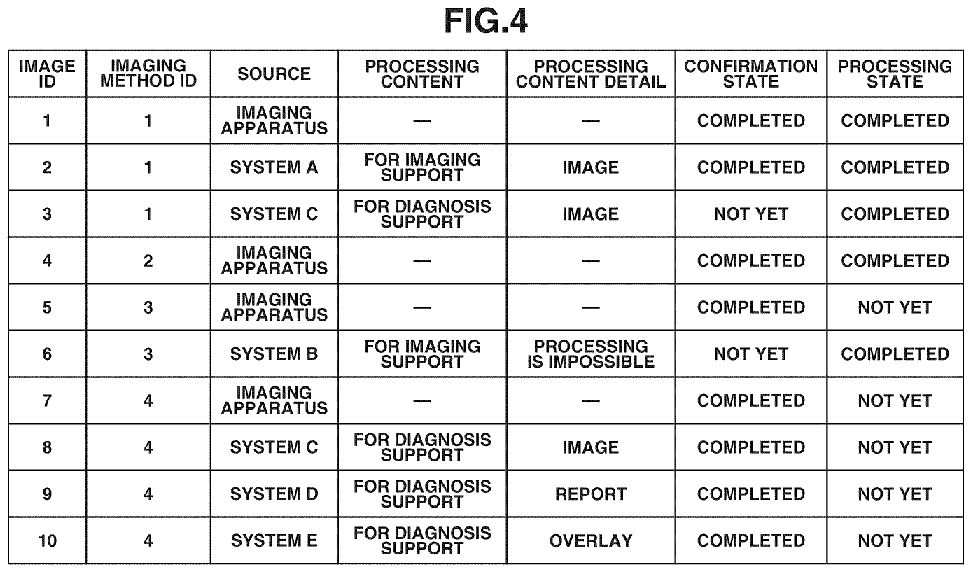

The inspection management unit 202 manages inspection information in which a radiation image and an inspection order are associated together. Specifically, the inspection management unit 202 manages an imaging protocol in which an imaging method, imaging conditions, and image processing conditions associated with the inspection order are defined. For example, in a case where the radiation imaging apparatus 100 generates inspection information, the inspection management unit 202 can also associate subject information and an imaging protocol input from the operation unit 140 and create new inspection information. In contrast, in a case where an inspection order is transmitted from the RIS 500, the inspection management unit 202 extracts an imaging protocol stored in the storage unit 203, by using protocol information regarding an imaging protocol associated with the inspection order received from the RIS 500. The inspection management unit 202 then associates the extracted imaging protocol and the inspection order and creates new inspection information. The newly created inspection information is stored in the storage unit 203. The inspection management unit 202 also associates a radiation image obtained by the radiation imaging apparatus 100 and an externally processed image obtained by each external processing apparatus 800, by using identification information (e.g., an imaging method ID in FIG. 4), and stores the radiation image and the externally processed image in the storage unit 203.

The storage unit 203 stores various images including a radiation image generated by the radiation detection unit 110 and various pieces of information, such as an inspection order, an imaging protocol, and an imaging method. The storage unit 203 also stores programs executed when the overall control unit 120 performs various types of control and various processes. The storage unit 203 also stores inspection information, an imaging protocol, and an imaging method associated with an inspection order by the inspection management unit 202, a radiation image output from the radiation detection unit 110, processing information and identification information input from the input/output unit 210, and various pieces of information required to manage an inspection. The storage unit 203 also stores, for example, setting information for setting whether each of the registered external processing apparatuses 800-A to 800-E is an external processing apparatus (an external processing system) that outputs a diagnosis support image.

The identification information acquisition unit 205 acquires identification information regarding processing information (which can include an externally processed image) input from the input/output unit 210.

The display/non-display determining unit 204 determines whether to display or not display a radiation image and an externally processed image on the display unit 160 based on identification information acquired by the identification information acquisition unit 205 and various pieces of information acquired from the storage unit 203.

The image processing unit 206 performs image processing on a radiation image obtained by the radiation detection unit 110. The image processing unit 206 performs the image processing on the radiation image using an imaging protocol and image information obtained by the imaging control unit 201. The radiation image subjected to the image processing is displayed on the display unit 160 and/or output from the input/output unit 210 to each external processing apparatus 800. The image processing unit 206 performs image processing for adjusting the image itself, such as adjusting the luminance and the contrast of the image. The image processing unit 206 can also perform an editing process, such as clipping and annotation, on the adjusted radiation image.

The system state determination unit 207 cooperates with the processing information determination unit 220 to determine the state of the radiation imaging system 10 (more specifically, the radiation imaging apparatus 100).

The display information acquisition unit 208 acquires information indicating whether an externally processed image is displayed on the display unit 160 once.

The input/output unit 210 outputs and inputs various images and various pieces of information to and from an external apparatus. For example, the input/output unit 210 receives the input of an inspection order from the RIS 500 and the input of processing information (which can include an externally processed image) from each external processing apparatus 800. For example, the input/output unit 210 outputs a radiation image to an external apparatus, such as the PACS 600, the printer 700, or each external processing apparatus 800 and outputs inspection execution information to the HIS 400. The input/output unit 210 includes a processing information reception unit 211. The processing information reception unit 211 receives and acquires processing information obtained as a result of each external processing apparatus 800 processing a radiation image output from the input/output unit 210.

The processing information determination unit 220 makes a determination regarding processing information acquired by the processing information reception unit 211. The processing information determination unit 220 includes a display control unit 221, a processing information display method control unit 222, and an output control unit 223. The display control unit 221, the processing information display method control unit 222, and the output control unit 223 compose a “control unit” according to the present disclosure, and will be described in detail below.

After associating inspection information and an imaging protocol managed by the inspection management unit 202, the imaging control unit 201 can also output a radiation image to not the image processing unit 206 but the input/output unit 210 and request each external processing apparatus 800 to perform image processing on the radiation image.

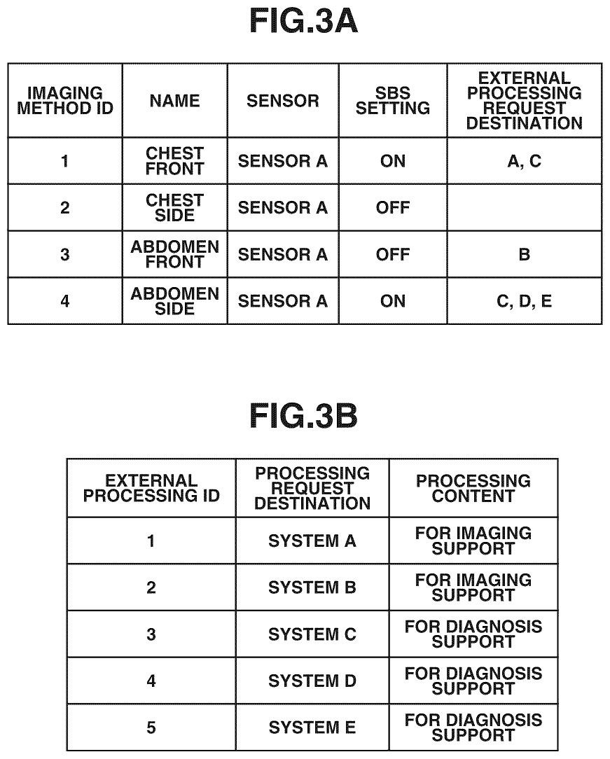

FIGS. 3A and 3B are diagrams illustrating examples of an imaging method table and an external processing table stored in the storage unit 203 illustrated in FIG. 2.

Specifically, FIG. 3A is a diagram illustrating an example of the imaging method table stored in the storage unit 203 illustrated in FIG. 2. The imaging method table illustrated in FIG. 3A is a table that stores, with respect to each imaging method, settings, such as an imaging method ID, the name of the imaging, a sensor type of the radiation detection unit 110 used in the imaging, a side-by-side display setting (an SBS setting), and an external processing request destination. The side-by-side display setting (the SBS setting) is a setting for displaying a plurality of images side by side in a single image display area. In the external processing request destination, “A” indicates the external processing apparatus 800-A (the external processing system A), “B” indicates the external processing apparatus 800-B (the external processing system B), “C” indicates the external processing apparatus 800-C (the external processing system C), “D” indicates the external processing apparatus 800-D (the external processing system D), and “E” indicates the external processing apparatus 800-E (the external processing system E).

FIG. 3B is a diagram illustrating an example of the external processing table stored in the storage unit 203 illustrated in FIG. 2. The external processing table illustrated in FIG. 3B is a table that stores, with respect to each external processing system, settings, such as an external processing ID, an external processing system as a processing request destination, and information indicating whether the external processing system as the processing request destination is for imaging support or for diagnosis support. For example, in the imaging of the abdomen front corresponding to the imaging method ID “3”, the external processing request destination is the external processing apparatus 800-B (the external processing system B) based on FIG. 3A, and a captured radiation image is transmitted to the external processing system B for imaging support based on FIG. 3B.

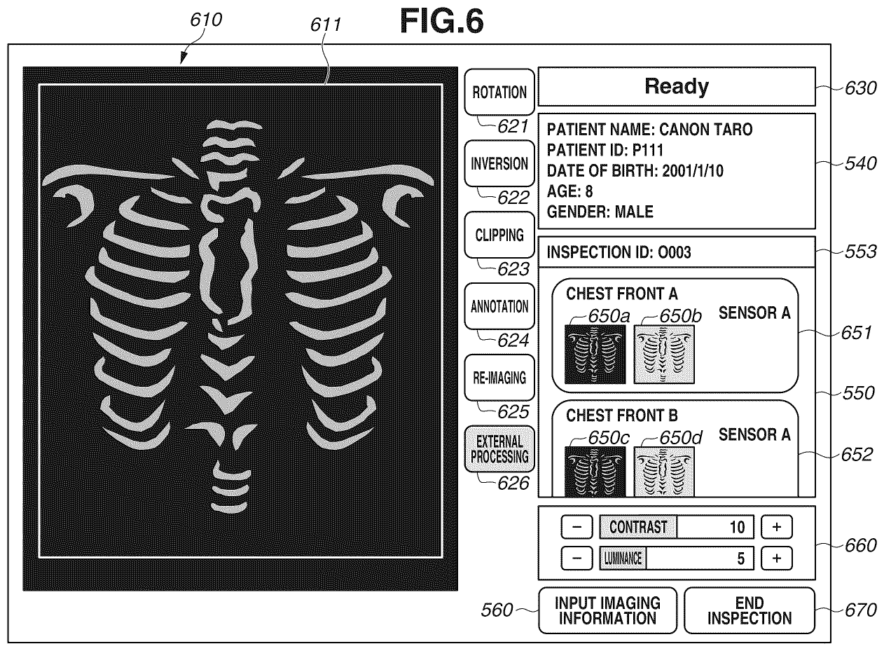

FIG. 4 is a diagram illustrating the first exemplary embodiment of the present disclosure and illustrating an example of an image table that stores image information regarding a radiation image obtained by the radiation imaging apparatus 100 illustrated in FIG. 1 and processing information (which can include an externally processed image) obtained by each external processing apparatus 800 illustrated in FIG. 1. The image table illustrated in FIG. 4 is a table that stores, with respect to each image, an image ID, an imaging method ID, a source having obtained the image, a processing content as information indicating whether an external processing system indicated by the source is for imaging support or for diagnosis support, a processing content detail, and a confirmation state and a processing state of the image. In the confirmation state of the image in the image table illustrated in FIG. 4, the confirmation of the image is completed by displaying the image in an image display area 610 in FIG. 6 described below. In the image table illustrated in FIG. 4, the processing content detail of the image indicates the type of processing information obtained as a result of any of the external processing apparatuses 800-A to 800-E (the external processing systems A to E) processing a radiation image obtained by the radiation imaging apparatus 100.

In line with the flow of an inspection of the subject 40 by the radiation imaging system 10 illustrated in FIG. 1, a processing procedure for capturing a radiation image will be described.

According to a written inspection request or an inspection request from the RIS 500, patient information as an example of subject information regarding the subject 40 and inspection information are firstly input through the operation unit 140 of the radiation imaging apparatus 100. The patient information includes a patient name and a patient ID. The inspection information includes imaging information defining the content of imaging to be executed on the patient.

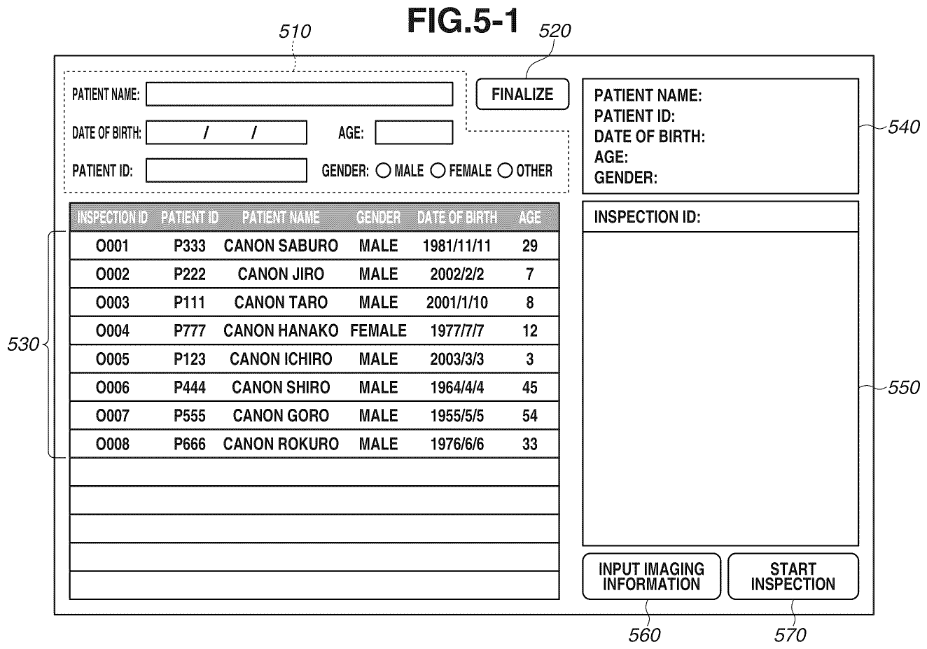

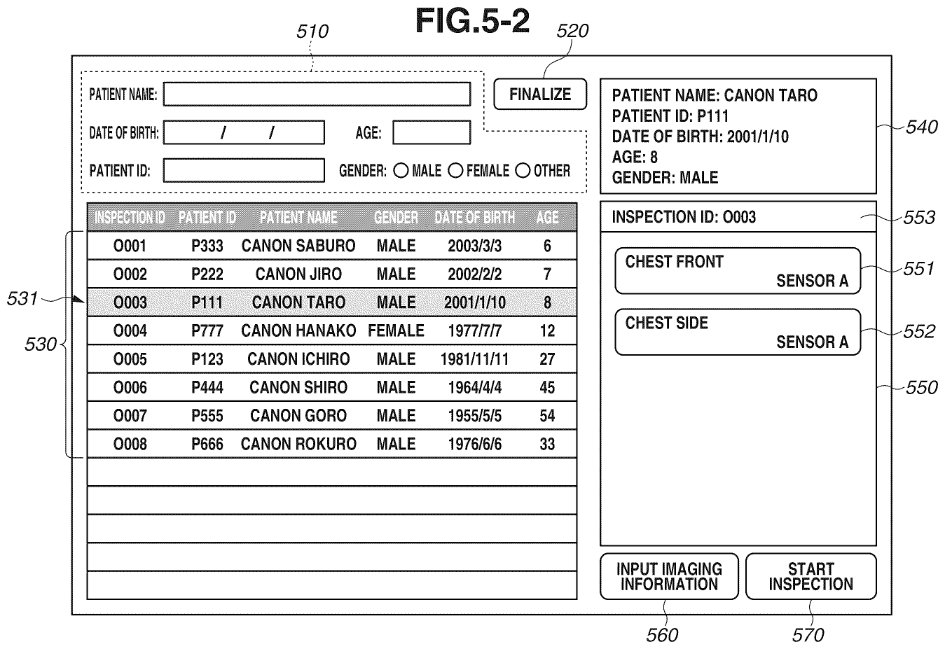

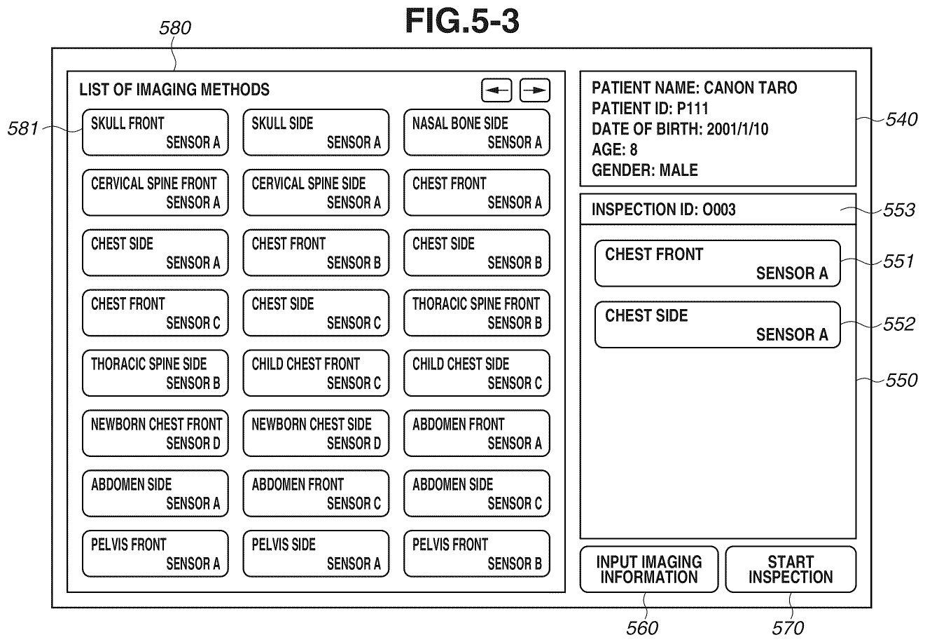

The radiation imaging apparatus 100 then displays a new inspection input screen on the display unit 160 based on control of the display control unit 150. FIGS. 5-1 and 5-2 are diagrams illustrating examples of the new inspection input screen displayed on the display unit 160 illustrated in FIG. 1. The new inspection input screen illustrated in FIG. 5-1 includes a patient information input area 510, a patient information finalization button 520, a requested inspection list 530, a patient information display area 540, an imaging information display area 550, an “input imaging information” button 560, and a “start inspection” button 570. In the requested inspection list 530 illustrated in FIG. 5-1, inspections received from the RIS 500 are arranged and displayed in a list.

If a single inspection 531 illustrated in FIG. 5-2 is selected from the requested inspection list 530 illustrated in FIG. 5-1, patient information (e.g., a patient ID, a patient name, and the date of birth) corresponding to the selected inspection 531 is then displayed in the patient information display area 540 as illustrated in FIG. 5-2. In the imaging information display area 550, an inspection ID corresponding to the selected inspection 531 is displayed in an inspection ID display area 553 as illustrated in FIG. 5-2. Further, in the imaging information display area 550, a “chest front” button 551 and a “chest side” button 552 as imaging method buttons corresponding to imaging information regarding the inspection ID are displayed in an area immediately below the inspection ID display area 553. The imaging information is received from the RIS 500.

FIG. 5-3 is a diagram illustrating an example of an imaging information input screen displayed on the display unit 160 illustrated in FIG. 1. The imaging information input screen illustrated in FIG. 5-3 is a screen displayed on the display unit 160 by the user pressing the “input imaging information” button 560 illustrated in FIG. 5-2 or the like. In FIG. 5-3, components similar to the components illustrated in FIGS. 5-1 and 5-2 are designated by the same signs, and are not described in detail. If the “input imaging information” button 560 illustrated in FIG. 5-2 is pressed, the display unit 160 displays a list of imaging methods in an imaging information input area 580 as illustrated in FIG. 5-3, and the user can also add an imaging method. In the example illustrated in FIG. 5-3, a plurality of imaging method selection buttons 581 is displayed in the imaging information input area 580, and the user can add an imaging method by selecting any of the imaging method selection buttons 581. The added imaging method is displayed alongside the “chest front” button 551 and the “chest side” button 552 in the imaging information display area 550. Each imaging method is associated with an imaging method ID.

If the user confirms the patient information and the imaging information and then presses the “start inspection” button 570, an inspection to be executed is finalized.

FIG. 6 is a diagram illustrating an example of an imaging screen displayed on the display unit 160 illustrated in FIG. 1. The imaging screen illustrated in FIG. 6 is a screen displayed on the display unit 160 by the user pressing the “start inspection” button 570 illustrated in FIG. 5-3 and the like, and is a screen used when radiation imaging of the subject 40 is performed. In FIG. 6, components similar to the components illustrated in FIGS. 5-1 to 5-3 are designated by the same signs, and are not described in detail.

On the imaging screen illustrated in FIG. 6, an image display area 610 and various buttons 621 to 626 are provided by replacing the patient information input area 510, the patient information finalization button 520, and the requested inspection list 530 on the new inspection input screen illustrated in FIG. 5-2. For example, the various buttons 621 to 626 illustrated in FIG. 6 are instruction buttons for an image displayed in the image display area 610. Specifically, a “rotation” button 621, an “inversion” button 622, a “clipping” button 623, an “annotation” button 624, a “re-imaging” button 625, and an “external processing” button 626 are provided as illustrated in FIG. 6.

On the imaging screen illustrated in FIG. 6, a message area 630 and an image processing setting area 660 are also added to the new inspection input screen illustrated in FIG. 5-2. On the imaging screen illustrated in FIG. 6, an “end inspection” button 670 is provided by replacing the “start inspection” button 570 on the new inspection input screen illustrated in FIG. 5-2. Further, on the imaging screen illustrated in FIG. 6, a “chest front A” button 651 including thumbnails 650a and 650b and a “chest front B” button 652 including thumbnails 650c and 650d are displayed in the imaging information display area 550. The thumbnail 650a is a thumbnail of a radiation image of a chest front A generated by the radiation imaging apparatus 100. The thumbnail 650b is a thumbnail of an externally processed image obtained by an external processing apparatus 800 processing the radiation image of the chest front A. The thumbnail 650c is a thumbnail of a radiation image of a chest front B generated by the radiation imaging apparatus 100. The thumbnail 650d is a thumbnail of an externally processed image obtained by an external processing apparatus 800 processing the radiation image of the chest front B.

Specifically, if the imaging screen illustrated in FIG. 6 is displayed on the display unit 160, the “chest front A” button 651 disposed at the top of the imaging information display area 550 is in a selected state by default. Accordingly, the overall control unit 120 of the radiation imaging apparatus 100 transmits imaging conditions (e.g., a tube voltage, a tube current, and an emission time) set corresponding to the “chest front A” button 651 (an imaging method) to the radiation generating apparatus control unit 130. The overall control unit 120 also controls the radiation detection unit 110 to be prepared for the radiation imaging of the subject 40 according to the imaging conditions. When the radiation imaging apparatus 100 is prepared for the radiation imaging of the subject 40, the overall control unit 120 causes the state of the radiation imaging apparatus 100 to transition to the state where imaging can be performed. At this time, a “Ready” message indicating the state where imaging can be performed is displayed in the message area 630 in the imaging screen illustrated in FIG. 6.

The user then checks the imaging method, sets the radiation imaging, and positions the patient as the subject 40. When a series of imaging preparations is completed, the user confirms with reference to the message area 630 that the radiation imaging apparatus 100 is in the state where imaging can be performed. Then, the user presses a radiation emission switch (not illustrated). As a result, the radiation generating apparatus 300 emits the radiation 301 toward a particular part of the patient as the subject 40, and the radiation detection unit 110 detects the radiation 301 having passed through the subject 40 and generates a radiation image of the subject 40.

When the radiation imaging of the subject 40 is completed, the overall control unit 120 of the radiation imaging apparatus 100 acquires the radiation image from the radiation detection unit 110 and also performs image processing on the acquired radiation image based on predetermined image processing conditions. The predetermined image processing conditions are defined in advance corresponding to the imaging method. When the image processing is completed, the radiation imaging apparatus 100 displays the radiation image subjected to the image processing in the image display area 610 illustrated in FIG. 6. The overall control unit 120 of the radiation imaging apparatus 100 also generates the thumbnail 650a of the radiation image generated by the radiation imaging apparatus 100 within the “chest front A” button 651.

If the user wants to change the contrast or the luminance of the radiation image displayed in the image display area 610 in FIG. 6, the user changes the contrast or the luminance by operating a “contrast” button or a “luminance” button provided in the image processing setting area 660.

If the user wants to change a clipping area of the radiation image displayed in the image display area 610 in FIG. 6, the user changes the clipping area to a desired clipping area by operating the “clipping” button 623 and a clipping frame 611. To assign a character string as diagnosis information, the user assigns a character string as indicated by an annotation on top of the image by operating the “annotation” button 624.

If the direction of the radiation image displayed in the image display area 610 in FIG. 6 is not suitable for a diagnosis, the user geometrically transforms the radiation image using the “rotation” button 621 or the “inversion” button 622 or the like. As described above, the user can execute additional image editing on the radiation image displayed in the image display area 610.

If the user wants to use image processing in the external processing apparatuses 800, the user presses the “external processing” button 626. In the imaging method table illustrated in FIG. 3A, whether to enable external processing by the external processing apparatuses 800 (a blank indicates that the external processing is not enabled) is set in advance in the external processing request destination. Further, if the external processing is enabled, an external processing apparatus 800 as the external processing request destination is set in advance.

In the external processing table illustrated in FIG. 3B, the type of the processing content (for imaging support or for diagnosis support) of the external processing apparatus 800 as the external processing request destination is set in the processing content.

For example, if an image in the “chest front A” button 651 is displayed in the image display area 610, the “external processing” button 626 is enabled according to the setting of whether to enable external processing by an imaging method corresponding to the “chest front A” button 651. If the user presses the “external processing” button 626, the radiation imaging apparatus 100 transmits a radiation image displayed in the image display area 610 to an external processing apparatus 800. The external processing apparatus 800 as the transmission destination is determined according to the external processing request destination set for the imaging method corresponding to the “chest front A” button 651. For example, in the imaging of the chest front corresponding to the “chest front A” button 651, the radiation image is transmitted to the external processing apparatuses 800-A and 800-C according to the external processing request destination in the imaging method table illustrated in FIG. 3A. To the radiation image to be transmitted, for example, the image ID illustrated in FIG. 4 is also added to a header portion of the radiation image to identify the radiation image itself. In an operation where image processing by the external processing apparatuses 800 is always used, an embodiment may be employed in which, using the generation of a radiation image according to radiation imaging as a trigger, the radiation image is transmitted without pressing the “external processing” button 626.

An inspection order received from the RIS 500 by the radiation imaging apparatus 100 includes imaging information. A configuration can be employed in which the HIS 400 or the RIS 500 requests the generation of an externally processed image by external processing by specifying an imaging method for which external processing is set to enabled.

If the radiation imaging apparatus 100 receives processing information (which can include an externally processed image) from the external processing apparatus 800, the radiation imaging apparatus 100 identifies an imaging method ID, based on the image ID in FIG. 4 having been assigned to the radiation image when the radiation image is transmitted to the external processing apparatus 800. The radiation imaging apparatus 100 then associates the radiation image transmitted to the external processing apparatus 800 and the processing information (which can include an externally processed image) received from the external processing apparatus 800. The association can be made by receiving information regarding the processing information through communication different from that for the reception of the processing information. For example, in the case of the imaging of the chest front A, an externally processed image associated with the radiation image is displayed as the thumbnail 650b of the externally processed image within the “chest front A” button 651. Thereafter, if the user presses the thumbnail 650b, the externally processed image of the chest front A is displayed in the image display area 610 in FIG. 6.

The user repeats the above procedure, thereby executing the radiation imaging using all imaging methods in the imaging information display area 550. When all the radiation imaging is completed, the user presses the “end inspection” button 670 illustrated in FIG. 6. Consequently, a series of inspection processes ends. The overall control unit 120 of the radiation imaging apparatus 100 assigns, to an image, information, such as the inspection information, the processing information, and the imaging conditions regarding the image, as additional information, and then outputs the image to the PACS 600, the printer 700, or the ROM of the radiation imaging apparatus 100, for example. The overall control unit 120 of the radiation imaging apparatus 100 transmits, to the HIS 400, inspection execution information for notifying the HIS 400 of an end of the inspection. At this time, the overall control unit 120 includes the identifier of processing information (which can include an externally processed image) received before the end of the inspection as an object within the inspection in the inspection execution information.

The radiation imaging apparatus 100 then displays the new inspection input screen illustrated in FIG. 5-1 on the display unit 160 again.

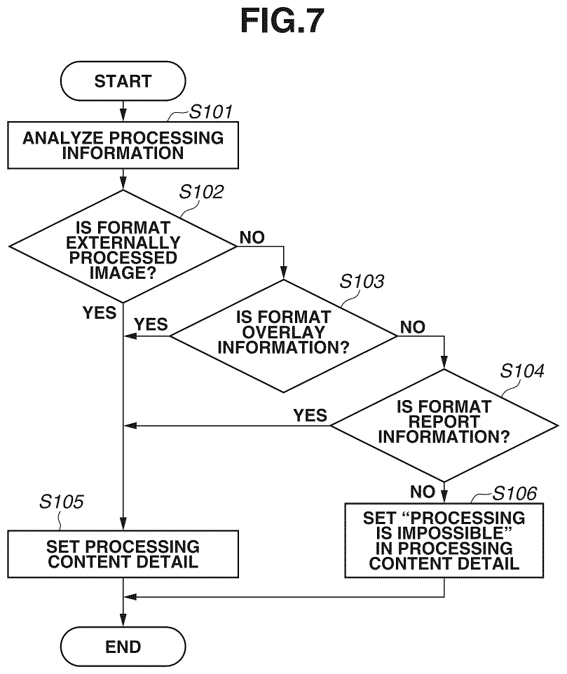

FIG. 7 is a flowchart illustrating an example of a processing procedure in a control method for controlling the radiation imaging apparatus 100 according to the first exemplary embodiment of the present disclosure. Specifically, the flowchart illustrated in FIG. 7 illustrates an example of a processing procedure in a process of obtaining processing information that is performed by the input/output unit 210 illustrated in FIG. 2.

If the user presses the “external processing” button 626 illustrated in FIG. 6, the input/output unit 210 outputs a radiation image that is being displayed in the image display area 610 illustrated in FIG. 6 to a specified external processing apparatus 800. Thereafter, the processing information reception unit 211 of the input/output unit 210 acquires processing information obtained as a result of processing the radiation image in the external processing apparatus 800 to which the radiation image is output. In step S101, the processing information reception unit 211 then analyzes the acquired processing information. Specifically, in the present exemplary embodiment, the processing information reception unit 211 analyzes a header portion of the acquired processing information.

In step S102, the processing information reception unit 211 determines whether the format of a real data portion, which is assigned following the header portion of the processing information acquired in step S101, is an externally processed image. The externally processed image is an image obtained as a result of an external processing apparatus 800 processing a radiation image obtained by the radiation imaging apparatus 100. If, as a result of the determination in step S102, the format of the real data portion of the processing information acquired in step S101 is the externally processed image (YES in step S102), the processing proceeds to step S105.

If, as a result of the determination in step S102, the format of the real data portion of the processing information acquired in step S101 is not the externally processed image (NO in step S102), the processing proceeds to step S103.

In step S103, the processing information reception unit 211 determines whether the format of the real data portion of the processing information acquired in step S101 is overlay information.

The overlay information is not information obtained by performing image processing on a radiation image itself obtained by the radiation imaging apparatus 100. The overlay information indicates an information object, such as a heat map or a measurement object, for superimposing useful information on the radiation image. If, as a result of the determination in step S103, the format of the real data portion of the processing information acquired in step S101 is the overlay information (YES in step S103), the processing proceeds to step S105.

If, as a result of the determination in step S103, the format of the real data portion of the processing information acquired in step S101 is not the overlay information (NO in step S103), the processing proceeds to step S104.

In step S104, the processing information reception unit 211 determines whether the format of the real data portion of the processing information acquired in step S101 is report information. The report information indicates inspection information or imaging information other than an image, or information regarding the character string or the numerical value of an attribute regarding diagnosis information or complementary information regarding a radiation image obtained by the radiation imaging apparatus 100. If, as a result of the determination in step S104, the format of the real data portion of the processing information acquired in step S101 is the report information (YES in step S104), the processing proceeds to step S105.

In step S105, the processing information reception unit 211 sets the processing content detail illustrated in FIG. 4, based on the information in the format of the real data portion of the processing information acquired in step S101. For example, if it is determined in step S102 that the format of the real data portion of the processing information is the externally processed image (YES in step S102), the processing information reception unit 211 sets “image” in the processing content detail illustrated in FIG. 4. For example, if it is determined in step S103 that the format of the real data portion of the processing information is the overlay information (YES in step S103), the processing information reception unit 211 sets “overlay” in the processing content detail illustrated in FIG. 4. For example, if it is determined in step S104 that the format of the real data portion of the processing information is the report information (YES in step S104), the processing information reception unit 211 sets “report” in the processing content detail illustrated in FIG. 4.

If, as a result of the determination in step S104, the format of the real data portion of the processing information acquired in step S101 is not the report information (NO in step S104), the processing proceeds to step S106.

In step S106, the processing information reception unit 211 sets “processing is impossible” in the processing content detail illustrated in FIG. 4.

When the process of step S106 is completed, the processing of the flowchart illustrated in FIG. 7 ends.

The information set in the processing content detail illustrated in FIG. 4 in the processing of the flowchart illustrated in FIG. 7 is referred to by, for example, the processing information determination unit 220.

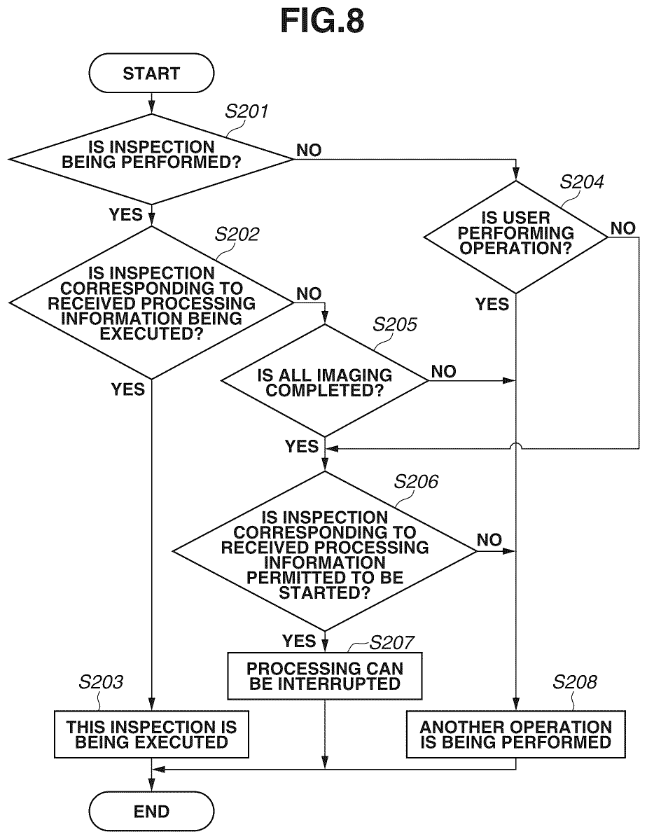

FIG. 8 is a flowchart illustrating an example of a processing procedure in the control method for controlling the radiation imaging apparatus 100 according to the first exemplary embodiment of the present disclosure. Specifically, the flowchart illustrated in FIG. 8 illustrates an example of a processing procedure regarding the determination of the state of the radiation imaging system 10 (more specifically, the radiation imaging apparatus 100) made by the system state determination unit 207 illustrated in FIG. 2.

To appropriately perform display control in view of also a case where the user is inspecting another patient and a case where the user is using the radiation imaging system 10 on another screen, the system state determination unit 207 determines the state of the radiation imaging apparatus 100. This determination performed by the system state determination unit 207 can be executed at every timing when processing information is received from an external processing apparatus 800, or can be executed not at the timing when processing information is received, but at a timing after the radiation imaging apparatus 100 waits a regular time. Further, the determination performed by the system state determination unit 207 can also be executed at the timing when the user starts an operation, or at a timing due to an operation, such as ending an inspection. Thus, the timing of the determination does not matter. In this case, the processing of the flowchart illustrated in FIG. 8 is started after the processing information reception unit 211 executes the processing of the flowchart illustrated in FIG. 7.

If the processing of the flowchart illustrated in FIG. 8 is started, the system state determination unit 207 determines, in step S201, whether the current radiation imaging apparatus 100 is executing an inspection.

If, as a result of the determination in step S201, the current radiation imaging apparatus 100 is executing an inspection (YES in step S201), the processing proceeds to step S202.

In step S202, the system state determination unit 207 determines whether an inspection including an image associated with the processing information received by the processing information reception unit 211 is being executed. For example, if the processing of the flowchart illustrated in FIG. 8 is executed at the timing when the processing information is received from the external processing apparatus 800, it is determined whether an inspection including an image of which the processing state illustrated in FIG. 4 is “not yet” and which is associated with the received processing information is being executed. The state where the processing state illustrated in FIG. 4 is “not yet” indicates that processing has not yet been executed based on the received processing information. If the processing of the flowchart illustrated in FIG. 8 is executed after the radiation imaging apparatus 100 waits the regular time, the determination is made on all pieces of processing information received while the radiation imaging apparatus 100 waits a certain period.

If, as a result of the determination in step S202, an inspection including an image associated with the processing information received by the processing information reception unit 211 is being executed (YES in step S202), the processing proceeds to step S203.

In step S203, the system state determination unit 207 determines that the state of the radiation imaging apparatus 100 is the state where this inspection is being executed.

If, as a result of the determination in step S201, the current radiation imaging apparatus 100 is not executing an inspection (NO in step S201), the processing proceeds to step S204.

In step S204, since an externally processed image corresponding to the processing information or image-related information should not be displayed by interrupting an operation of an operator as the user, the system state determination unit 207 determines whether the user is currently performing an operation. In this case, for example, if an operation is not performed on the operation unit 140 for a certain period, it is determined that the user is not performing an operation.

If, as a result of the determination in step S204, the user is not currently performing an operation (NO in step S204), the processing proceeds to step S206. If, in contrast, as a result of the determination in step S204, the user is currently performing an operation (YES in step S204), the processing proceeds to step S208.

If, as a result of the determination in step S202, an inspection including an image associated with the processing information received by the processing information reception unit 211 is not being executed (NO in step S202), the processing proceeds to step S205.

In step S205, the system state determination unit 207 determines whether all the imaging is completed.

If, as a result of the determination in step S205, all the imaging is completed (YES in step S205), the processing proceeds to step S206. The situation where the processing proceeds from step S205 to step S206 is the situation where imaging to be executed in the inspection is completed. The situation where the processing proceeds from step S204 to step S206 is the situation where the user is not particularly performing an operation, and the processing can be interrupted to display the processing information.

Thus, in step S206, the system state determination unit 207 performs, on the display unit 160, display that asks the user to determine whether to allow the inspection corresponding to the received processing information to be started. The system state determination unit 207 then determines whether to permit the inspection corresponding to the received processing information to be started.

If, as a result of the determination in step S206, the inspection corresponding to the received processing information is permitted to be started (YES in step S206), the processing proceeds to step S207.

In step S207, the system state determination unit 207 determines that the state of the radiation imaging apparatus 100 is the state where the processing can be interrupted. Thereafter, the inspection on hold including the image associated with the received processing information can be started to display the received processing information.

If it is determined in step S205 that all the imaging is not completed (NO in step S205), or if it is determined in step S206 that the inspection corresponding to the received processing information is not permitted to be started (NO in step S206), the processing proceeds to step S208. The situation where the processing proceeds to step S208 is the situation where the user is in the middle of executing another operation or another inspection, and it is possible that a series of operations is not completed if the inspection including the associated image is started at this timing.

Thus, in step S208, the system state determination unit 207 determines that the state of the radiation imaging apparatus 100 is the state where another operation is being performed.

If the process of step S203 is completed, or if the process of step S207 is completed, or if the process of step S208 is completed, the processing of the flowchart illustrated in FIG. 8 ends. The state of the radiation imaging apparatus 100 determined by the system state determination unit 207 by the processing of the flowchart illustrated in FIG. 8 is used, for example, as input information by the processing information determination unit 220.

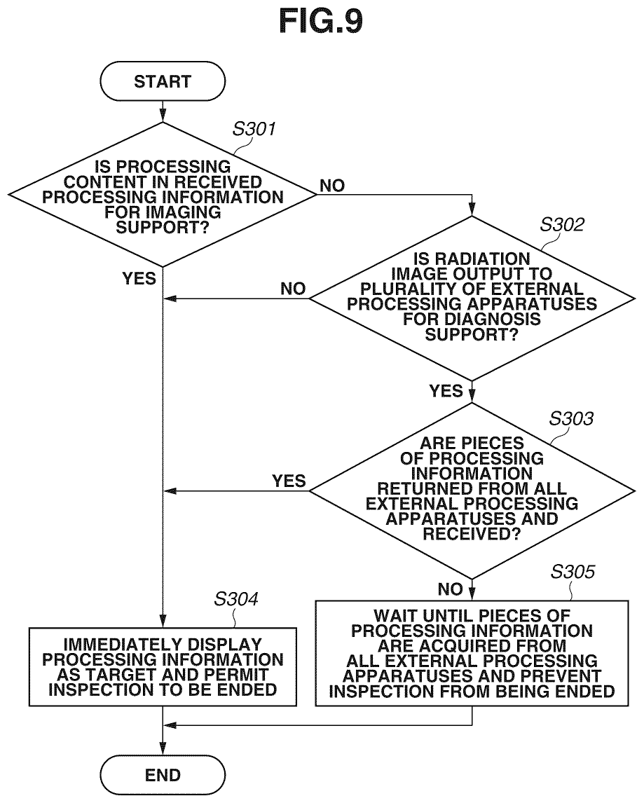

FIG. 9 is a flowchart illustrating an example of a processing procedure in the control method for controlling the radiation imaging apparatus 100 according to the first exemplary embodiment of the present disclosure. Specifically, the flowchart illustrated in FIG. 9 is a flowchart illustrating an example of a processing procedure regarding the display setting of processing information made by the display control unit 221 of the processing information determination unit 220.

The processing of the flowchart illustrated in FIG. 9 can be executed after the system state determination unit 207 determines the state of the radiation imaging apparatus 100 as illustrated in FIG. 8. For example, the processing of the flowchart illustrated in FIG. 9 is processing when control for displaying the processing information on the display unit 160 is performed in a case where an image is displayed when the state of the radiation imaging apparatus 100 is the state where the inspection is being performed, or in a case where the inspection on hold is started when the state of the radiation imaging apparatus 100 is the state where the processing can be interrupted. In the present exemplary embodiment, the control for displaying the processing information on the display unit 160 is performed using the result of determining the state of the radiation imaging apparatus 100 by the processing of the flowchart illustrated in FIG. 8 and the processing content illustrated in FIG. 4 as inputs. Based on the type of the “processing content” illustrated in FIG. 4, in the present exemplary embodiment, external processing apparatuses 800 that perform processing for imaging support (the external processing apparatuses 800-A and 800-B) and external processing apparatuses 800 that perform processing for diagnosis support (the external processing apparatuses 800-C to 800-E) are present.

If the processing of the flowchart illustrated in FIG. 9 is started, the display control unit 221 determines, in step S301, whether the type of the processing content in the processing information received by the processing information reception unit 211 is for imaging support.

If, as a result of the determination in step S301, the type of the processing content in the processing information received by the processing information reception unit 211 is not for imaging support (i.e., is for diagnosis support) (NO in step S301), the processing proceeds to step S302.

In step S302, the display control unit 221 determines whether the radiation image to be displayed is output to another external processing apparatus 800 for diagnosis support. That is, the display control unit 221 determines, in step S302, whether the radiation image to be displayed is output to a plurality of external processing apparatuses 800 for diagnosis support.

If, as a result of the determination in step S302, the radiation image to be displayed is output to a plurality of external processing apparatuses 800 for diagnosis support (YES in step S302), the processing proceeds to step S303.

In step S303, the display control unit 221 determines whether pieces of processing information are returned from all the external processing apparatuses 800 for diagnosis support to which the radiation image to be displayed is output, and are received (acquired) by the processing information reception unit 211.

If, as a result of the determination in step S303, pieces of processing information are returned from all the external processing apparatuses 800 for diagnosis support, and are received (acquired) by the processing information reception unit 211 (YES in step S303), the processing proceeds to step S304. If, as a result of the determination in step S301, the type of the processing content in the processing information received by the processing information reception unit 211 is for imaging support (YES in step S301), the processing proceeds to step S304. Even if, as a result of the determination in step S302, the radiation image to be displayed is not output to a plurality of external processing apparatuses 800 for diagnosis support (NO in step S302), the processing proceeds to step S304.

In step S304, the display control unit 221 performs control to immediately display processing information as a target on the display unit 160 and also performs control to permit the inspection to be ended.

Processing for imaging support is a process of providing support regarding the success or failure of the radiation imaging or the accuracy of the captured radiation image. Thus, if the radiation imaging is required again, it is desirable that the radiation imaging should be performed as soon as possible in view of the burden on the patient. Thus, in step S304, the display control unit 221 performs control to immediately display processing information returned from an external processing apparatus 800. If pieces of processing information are returned from all the external processing apparatuses 800, the display control unit 221 performs control to permit the inspection to be ended any time.

If, as a result of the determination in step S303, pieces of processing information are not returned from all the external processing apparatuses 800 for diagnosis support, and are not received by the processing information reception unit 211 (NO in step S303), the processing proceeds to step S305. The case where the processing proceeds to step S305 is the case where the radiation image is output to a plurality of external processing apparatuses 800 for diagnosis support, but pieces of processing information are not returned from all the external processing apparatuses 800 for diagnosis support.

In step S305, the display control unit 221 waits to display processing information until pieces of processing information are acquired from all the external processing apparatuses 800 for diagnosis support to which the radiation image as the target is output, and performs control to prevent the inspection from being ended.

When the display control unit 221 displays processing information (an externally processed image or image-related information) on the display unit 160, a plurality of pieces of processing information (the image ID “8”, the image ID “9”, and the image ID “10”) may be present for a single radiation image (the image ID “7”) as illustrated in FIG. 4. Each external processing apparatus 800 is another apparatus unrelated to the radiation imaging apparatus 100, and a response to requested processing from the external processing apparatus 800 can be delayed, or processing information can be returned from the external processing apparatus 800 at a timing unintended by the user. If pieces of processing information are returned in order from the external processing apparatuses 800 for diagnosis support, the need can arise for the user to confirm the processing information each time processing information is acquired. Since the user may be a doctor not a photographer, it is efficient to collectively reference these pieces of processing information for diagnosis support, and this is also useful for a diagnosis. Thus, in step S305, the display control unit 221 waits to display processing information and does not immediately display processing information until pieces of processing information are acquired from all the external processing apparatuses 800 for diagnosis support to which the radiation image as the target is output. In this case, the display control unit 221 makes a setting for preventing the inspection from being ended during this waiting period. Thus, the display control unit 221 needs to perform control to prevent the user from pressing the “end inspection” button 670 illustrated in FIG. 6. Alternatively, the “end inspection” button 670 can be allowed to be pressed, but the inspection can be saved in an on-hold state. Although the method does not matter as described above, it is desirable to prevent the inspection from being logically ended until pieces of processing information are obtained from all the external processing apparatuses 800. If the inspection should be ended before pieces of processing information are returned from all the external processing apparatuses 800, processing information can be newly displayed on an inspection confirmation screen for confirming a completed inspection, or processing information can be individually displayed on an image-by-image basis.

If the process of step S304 is completed, or if the process of step S305 is completed, the processing of the flowchart illustrated in FIG. 9 ends.

Based on the display control in the flowchart illustrated in FIG. 9, if the type of the processing content in the received processing information is for imaging support, the processing information is immediately displayed. Thus, if there is a problem, re-imaging can be immediately performed. If the type of the processing content in the received processing information is for diagnosis support, a plurality of pieces of processing information for diagnosis support is acquired and then collectively displayed. Thus, it is possible to improve the quality of a list of pieces of processing information for the user. In a case where the plurality of pieces of processing information for diagnosis support is collectively displayed, and if the pieces of processing information are uniformly displayed in the state where the layout of the pieces of processing information is not adjusted, the pieces of processing information may overlap each other. In this case, a button for switching the display and the non-display of the pieces of processing information from the external processing apparatuses 800 can be prepared on the imaging screen illustrated in FIG. 6, for example. Alternatively, for example, an embodiment can also be employed in which a layout control unit for processing information is added as an internal component of the overall control unit 120, an image and processing information are analyzed, and pieces of processing information are laid out so as not to overlap each other.

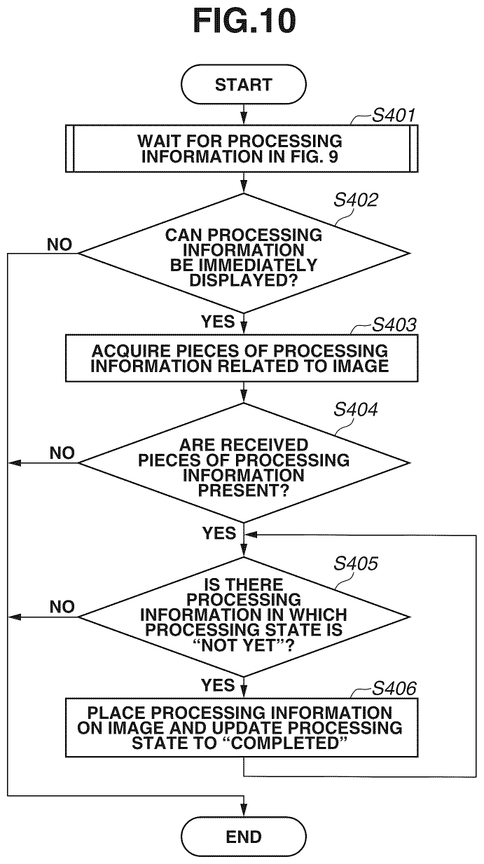

FIG. 10 is a flowchart illustrating an example of a processing procedure in the control method for controlling the radiation imaging apparatus 100 according to the first exemplary embodiment of the present disclosure. Specifically, the flowchart illustrated in FIG. 10 is a flowchart illustrating an example of a processing procedure regarding display control of processing information by the processing information display method control unit 222 of the processing information determination unit 220. The processing information display method control unit 222 performs control when processing information (a radiation image or image-related information) received from an external processing apparatus 800 is displayed on the display unit 160 so that the user can confirm the processing information.

If the processing of the flowchart illustrated in FIG. 10 is started, then in step S401, the processing of the flowchart illustrated in FIG. 9 is performed.

In step S402, the processing information display method control unit 222 determines whether processing information can be immediately displayed, based on the result of the process of step S401.

If, as a result of the determination in step S402, processing information can be immediately displayed (YES in step S402), the processing proceeds to step S403.

In step S403, the processing information display method control unit 222 acquires pieces of processing information in which the processing state illustrated in FIG. 4 is “not yet” among pieces of processing information related to the radiation image to be displayed or externally processed images from the external processing apparatuses 800. This process is specifically described with reference to FIG. 4. In FIG. 4, the image ID “7” corresponds to a radiation image captured by the radiation imaging apparatus 100, and the image ID “8”, the image ID “9”, and the image ID “10” correspond to pieces of processing information processed by external processing apparatuses 800. Based on information regarding the imaging method ID illustrated in FIG. 4, the processing request destination of the radiation image corresponding to the image ID “7” is the external processing apparatus 800-C (the external processing system C), the external processing apparatus 800-D (the external processing system D), and the external processing apparatus 800-E (the external processing system E). Thus, candidates for the pieces of processing information to be acquired in step S403 are pieces of processing information corresponding to the image ID “8”, the image ID “9”, and the image ID “10”. The image ID “8”, however, corresponds to an externally processed image and cannot be superimposed on a radiation image captured by the radiation imaging apparatus 100, and therefore is not included in the pieces of processing information to be acquired in step S403. That is, the pieces of processing information to be acquired in step S403 are, in this case, the pieces of processing information corresponding to the image ID “9” and the image ID “10”.

In step S404, the processing information display method control unit 222 determines whether the received pieces of processing information are present (acquired).

If, as a result of the determination in step S404, the received pieces of processing information are present (acquired) (YES in step S404), the processing proceeds to step S405. If at least one piece of processing information is present (acquired), the processing proceeds to step S405.

In step S405, the processing information display method control unit 222 determines whether there is processing information in which the processing state illustrated in FIG. 4 is “not yet”.

If, as a result of the determination in step S405, there is processing information in which the processing state illustrated in FIG. 4 is “not yet” (YES in step S405), the processing proceeds to step S406.

In step S406, the processing information display method control unit 222 places a single piece of processing information in which the processing state illustrated in FIG. 4 is “not yet” on the radiation image or the externally processed image using the image processing unit 206. The processing information display method control unit 222 then updates the processing state in the single piece of processing information from “not yet” to “completed”. As a method for displaying the processing information by placing the processing information, for example, a method for assigning priorities to a plurality of external processing apparatuses 800 and superimposing pieces of processing information according to the order of the priorities, or a method for superimposing pieces of processing information according to the order of reception of the pieces of processing information from external processing apparatuses 800 can be employed. Alternatively, the display of processing information having a high priority may be prioritized, and processing information having a lower priority may not be displayed.

Additionally, as a method for displaying the processing information by placing the processing information on the radiation image, for example, after processing information having a high priority is displayed for a certain time, processing information having the next high priority can be displayed. In this manner, pieces of processing information can be displayed by switching the pieces of processing information in descending order of priorities.

When the process of step S406 is completed, the processing returns to step S405, and the processes of step S405 and the subsequent steps are performed again.

If, as a result of the determination in step S405, there is not processing information in which the processing state illustrated in FIG. 4 is “not yet” (NO in step S405), the processing of the flowchart illustrated in FIG. 10 ends. Further, if, as a result of the determination in step S402, processing information cannot be immediately displayed (NO in step S402), or if, as a result of the determination in step S404, the received pieces of processing information are not present (NO in step S404), the processing of the flowchart illustrated in FIG. 10 ends.

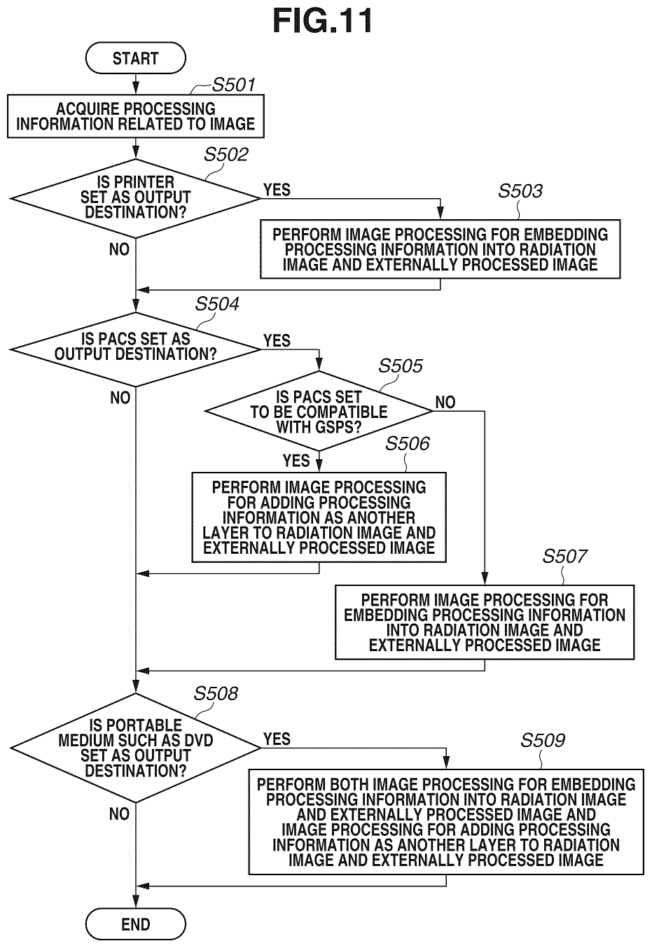

FIG. 11 is a flowchart illustrating an example of a processing procedure in the control method for controlling the radiation imaging apparatus 100 according to the first exemplary embodiment of the present disclosure. Specifically, the flowchart illustrated in FIG. 11 is a flowchart illustrating an example of a processing procedure regarding output control of an image to which processing information is added by the output control unit 223 of the processing information determination unit 220. The flowchart illustrated in FIG. 11 is, for example, a flowchart of output control of an image to which processing information is added that is executed when an inspection ends or at any timing after an inspection ends. Examples of the output destination of the image to which the processing information is added include the PACS 600 and the printer 700, which are different from the external processing apparatuses 800, a portable medium such as a DVD, and further, the ROM of the radiation imaging apparatus 100.

If the processing of the flowchart illustrated in FIG. 11 is started, the output control unit 223 firstly acquires, in step S501, processing information related to a radiation image or an externally processed image to be output. The process of step S501 is a process similar to the process of step S403 illustrated in FIG. 10, and therefore is not described.

In step S502, the output control unit 223 determines whether the printer 700 is set as the output destination.

If, as a result of the determination in step S502, the printer 700 is set as the output destination (YES in step S502), the processing proceeds to step S503.

In step S503, the output control unit 223 performs image processing for embedding the processing information acquired in step S501 into the radiation image to be output to the printer 700 (and if an externally processed image is present, further, the externally processed image). Consequently, an output image obtained by adding the processing information to the radiation image (and if an externally processed image is present, further, the externally processed image) is generated, and the output control unit 223 performs control to output the generated output image to the printer 700. In the printer 700, all pieces of information are placed on a single film, and therefore, the output control unit 223 performs control to generate an output image obtained by adding the processing information to the image itself and output the output image to the printer 700.

If the process of step S503 is completed, or if it is determined in step S502 that the printer 700 is not set as the output destination (NO in step S502), the processing proceeds to step S504.

In step S504, the output control unit 223 determines whether the PACS 600 is set as the output destination.

If, as a result of the determination in step S504, the PACS 600 is set as the output destination (YES in step S504), the processing proceeds to step S505.

In step S505, the output control unit 223 determines whether the PACS 600 set as the output destination is compatible with the Grayscale Softcopy Presentation State (GSPS).

If, as a result of the determination in step S505, the PACS 600 set as the output destination is compatible with the GSPS (YES in step S505), the processing proceeds to step S506.

In step S506, since the PACS 600 set as the output destination is compatible with the GSPS, the output control unit 223 performs image processing so that a single piece of processing information can be output using an individual GSPS object. Specifically, in step S506, the output control unit 223 performs image processing for adding the processing information acquired in step S501 as another layer to the radiation image to be output to the PACS 600 (and if an externally processed image is present, further, the externally processed image). Consequently, an output image obtained by adding the processing information as another layer to the radiation image (and if an externally processed image is present, further, the externally processed image) is generated, and the output control unit 223 performs control to output the generated output image to the PACS 600.

If, as a result of the determination in step S505, the PACS 600 set as the output destination is not compatible with the GSPS (NO in step S505), the processing proceeds to step S507.

In step S507, since the PACS 600 set as the output destination is not compatible with the GSPS, the output control unit 223 performs a process similar to the process of step S503. That is, in step S507, the output control unit 223 performs image processing for embedding the processing information acquired in step S501 into the radiation image to be output to the PACS 600 (and if an externally processed image is present, further, the externally processed image). More specifically, the output control unit 223 performs control to generate an output image obtained by adding the processing information to the image itself and output the output image to the PACS 600.

If the process of step S506 is completed, or if the process of step S507 is completed, the processing proceeds to step S508.

In step S508, the output control unit 223 determines whether the portable medium such as a DVD is set as the output destination.

If, as a result of the determination in step S508, the portable medium such as a DVD is set as the output destination (YES in step S508), the processing proceeds to step S509.

In step S509, since it is not known whether an image display device using the portable medium such as a DVD as the output destination can display the processing information, the output control unit 223 performs both the image processing in step S503 or S507 and the image processing in S506. That is, the output control unit 223 generates a first output image by performing the image processing for embedding the processing information acquired in step S501 into the radiation image to be output to the portable medium such as a DVD (and if an externally processed image is present, further, the externally processed image). The output control unit 223 also generates a second output image by performing the image processing for adding the processing information acquired in step S501 as another layer to the radiation image to be output to the portable medium such as a DVD (and if an externally processed image is present, further, the externally processed image). The output control unit 223 then performs control to output the generated first and second output images to the portable medium such as a DVD. If the output control unit 223 simultaneously saves auxiliary image display software when outputting the output images to the portable medium such as a DVD, the output control unit 223 does not need to output both the first and second output images, and may only need to output only an output image in a format that can be displayed by the auxiliary software.

If the process of step S509 is completed, or if it is determined in step S508 that the portable medium such as a DVD is not set as the output destination (NO in step S508), the processing of the flowchart illustrated in FIG. 11 ends.

A case is also assumed where a plurality of pieces of processing information is returned from a single external processing apparatus 800. In this case, if the number of captured radiation images increases, many pieces of processing information need to be handled according to the increase.

In the radiation imaging apparatus 100 according to the first exemplary embodiment, the radiation detection unit 110 detects the radiation 301 incident on the radiation detection unit 110 and generates a radiation image. The input/output unit 210 (an acquisition unit) transmits the radiation image generated by the radiation detection unit 110 to an external processing apparatus 800 as a processing request destination, and acquires processing information obtained by the external processing apparatus 800 as the processing request destination processing the radiation image from the external processing apparatus 800 as the processing request destination. Further, according to a type of a processing content in the processing information acquired by the input/output unit 210, the control units 221 to 223 (control units) of the processing information determination unit 220 perform control to determine whether to immediately display the processing information, or after a plurality of pieces of processing information in which the processing content is of the same type is acquired, display the plurality of pieces of processing information. Specifically, in a case where the processing content in the processing information is for imaging support, the control units 221 to 223 (the control units) of the processing information determination unit 220 perform control to immediately display the processing information on the display unit 160. In a case where the processing content in the processing information is for diagnosis support, the control units 221 to 223 (the control units) of the processing information determination unit 220 perform control to, after a plurality of pieces of processing information in which the processing content is for diagnosis support is acquired, display the plurality of pieces of processing information on the display unit 160.

According to this configuration, the user can efficiently perform the work of confirming processing information obtained as a result of an external processing apparatus 800 processing a radiation image. For example, if an external processing apparatus 800 for imaging support processes a radiation image, the user needs to confirm processing information regarding the radiation image as soon as possible and grasp whether the radiation image is appropriately captured. If an external processing apparatus 800 for diagnosis support processes a radiation image, it is desirable that the user should be allowed to collectively confirm many pieces of processing information, which is efficient. Based on control of the control units 221 to 223 (the control units), the user can efficiently perform the work of confirming processing information both in a case where the processing content is for imaging support and in a case where the processing content is for diagnosis support.

Next, a second exemplary embodiment is described. In the following description of the second exemplary embodiment, items common to the first exemplary embodiment are not described, and items different from the first exemplary embodiment are described.

The first exemplary embodiment has assumed a case where processing information from an external processing apparatus 800 is information in which a set of pieces of data is completed in a single unit (or a single file). In contrast, the second exemplary embodiment is an embodiment assuming a case where processing information from an external processing apparatus 800 is information in which a header portion and a real data portion are in different sets of pieces of data (separate files).

The schematic configuration of the radiation imaging system according to the second exemplary embodiment is similar to the schematic configuration of the radiation imaging system 10 according to the first exemplary embodiment illustrated in FIG. 1. The schematic configuration of the overall control unit 120 according to the second exemplary embodiment is similar to the general configuration of the overall control unit 120 according to the first exemplary embodiment illustrated in FIG. 2.

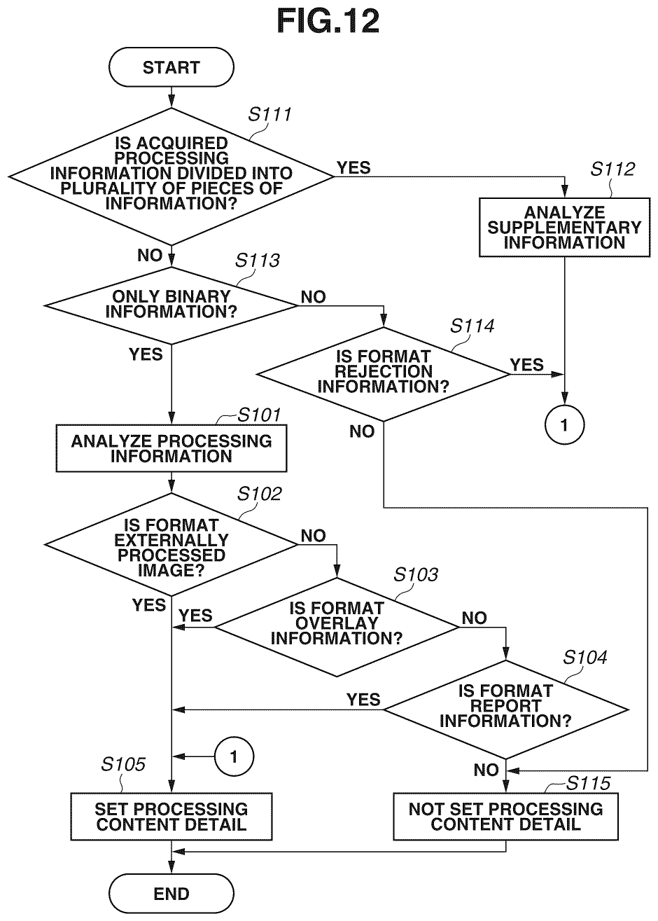

FIG. 12 is a flowchart illustrating an example of a processing procedure in a control method for controlling the radiation imaging apparatus 100 according to the second exemplary embodiment of the present disclosure. Specifically, the flowchart illustrated in FIG. 12 illustrates an example of a processing procedure in a process of obtaining processing information that is performed by the input/output unit 210 illustrated in FIG. 2. In FIG. 12, processing steps similar to the processing steps illustrated in FIG. 7 are designated by the same step numbers, and are not described in detail.

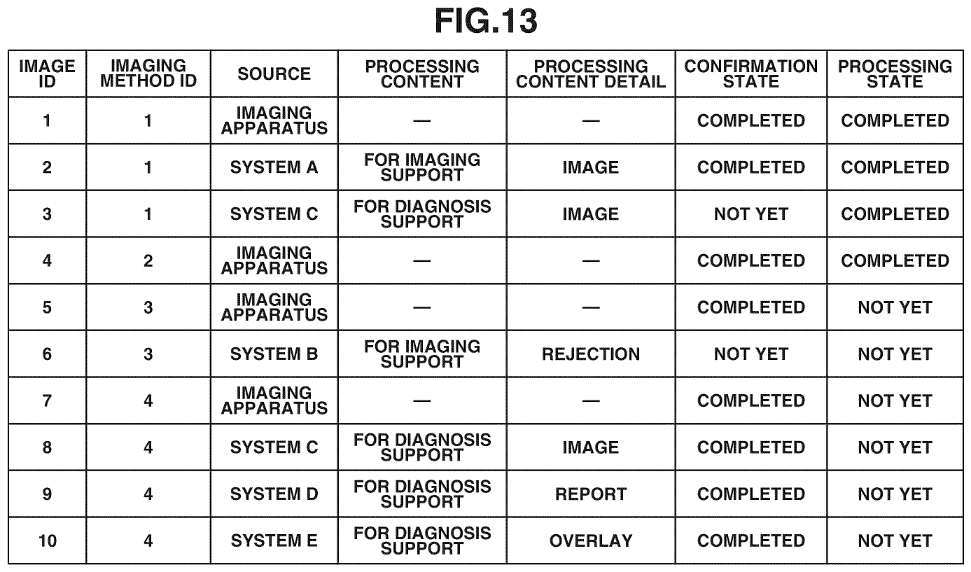

FIG. 13 is a diagram illustrating the second exemplary embodiment of the present disclosure. FIG. 13 illustrates an example of an image table that stores image information regarding a radiation image obtained by the radiation imaging apparatus 100 illustrated in FIG. 1 and processing information (which can include an externally processed image) obtained by each external processing apparatus 800. In FIG. 13, components similar to the components illustrated in FIG. 4 are described in a similar manner, and are not described in detail. Similarly to FIG. 4, the image table illustrated in FIG. 13 is a table that stores an image ID, an imaging method ID, a source, a processing content, a processing content detail, a confirmation state, and a processing state. The flowchart illustrated in FIG. 12 is described below with reference to FIG. 13 where necessary.

If the processing of the flowchart illustrated in FIG. 12 is started, the processing information reception unit 211 of the input/output unit 210 firstly determines, in step S111, whether processing information acquired from an external processing apparatus 800 to which a radiation image is output is divided into a plurality of pieces of information.

If, as a result of the determination in step S111, the processing information acquired from the external processing apparatus 800 to which the radiation image is output is divided into a plurality of pieces of information (YES in step S111), the processing proceeds to step S112.

In step S112, the processing information reception unit 211 analyzes supplementary information in the processing information. The supplementary information is information for control required to process a real data portion. For example, if the processing information is regarding an externally processed image, the supplementary information corresponding to image data of the externally processed image is assigned. At this time, the supplementary information is, for example, text information and is information identifying a corresponding real data portion (e.g., a file name), the processing content detail (e.g., the externally processed image, the overlay information, or the report information), or the image ID identifying the radiation image as the original image. Depending on the type of the data, further detailed information, such as the format of the image or the processing content of the image processing, may also be required. To facilitate processing after the processing information is obtained, inspection information or information regarding a part may be held as the supplementary information.

The supplementary information is analyzed in step S112, whereby it is possible to identify the processing content detail. The processing then proceeds to step S105.

If, as a result of the determination in step S111, the processing information acquired from the external processing apparatus 800 to which the radiation image is output is not divided into a plurality of pieces of information (NO in step S111), the processing proceeds to step S113.

In step S113, the processing information reception unit 211 determines whether the processing information acquired from the external processing apparatus 800 to which the radiation image is output has only binary information.

If, as a result of the determination in step S113, the processing information acquired from the external processing apparatus 800 to which the radiation image is output is not only binary information (NO in step S113), the processing proceeds to step S114.

In step S114, the processing information reception unit 211 determines whether the format of the supplementary information in the processing information acquired from the external processing apparatus 800 to which the radiation image is output is the rejection information. The rejection information is information that is returned as processing information from the external processing apparatus 800 in a case where a radiation image output to an external processing apparatus 800 has an imaging problem. For example, examples of the case where the rejection information is returned as processing information include a case where the body movement of the patient as the imaging target is detected, a case where a part different from the imaging target part of the patient is at the center of the radiation image, and a case where an intended part is not captured because the angle of capturing the patient is incorrect. An image is not returned from the external processing apparatus 800 having processed such a radiation image. In the rejection information, the image ID illustrated in FIG. 13, the reason for the rejection, and whether re-imaging is necessary are set to identify the radiation image as the original image.

If, as a result of the determination in step S114, the format of the supplementary information in the processing information is the rejection information (YES in step S114), the processing proceeds to step S105 so that the rejection information is set in the processing content detail illustrated in FIG. 13. Specifically, FIG. 13 illustrates a case where the format of the supplementary information in processing information corresponding to the image ID “6” is the rejection information, and an example where “rejection” is set in the processing content detail in step S105.

If, as a result of the determination in step S114, the format of the supplementary information in the processing information is not the rejection information (NO in step S114), the processing proceeds to step S115.

In step S115, the processing information reception unit 211 performs a process of not setting in the processing content detail illustrated in FIG. 13.

If, as a result of the determination in step S113, the processing information acquired from the external processing apparatus 800 to which the radiation image is output has only binary information (YES in step S113), the processing proceeds to step S101. Then, processing similar to the processing of the flowchart illustrated in FIG. 7 is performed.

In the processing of the flowchart illustrated in FIG. 12, an embodiment is employed in which if, as a result of the determination in step S104, the format of the real data portion of the processing information acquired in step S101 is not the report information (NO in step S104), the processing proceeds to step S115.

If a real data portion and supplementary information in processing information can be separately obtained as in the present exemplary embodiment, only supplementary information can also be received as processing information from an external processing apparatus 800. In this case, rejection information can also be acquired by receiving text information having only the supplementary information from the external processing apparatus 800. This also reduces operation burden on the user.

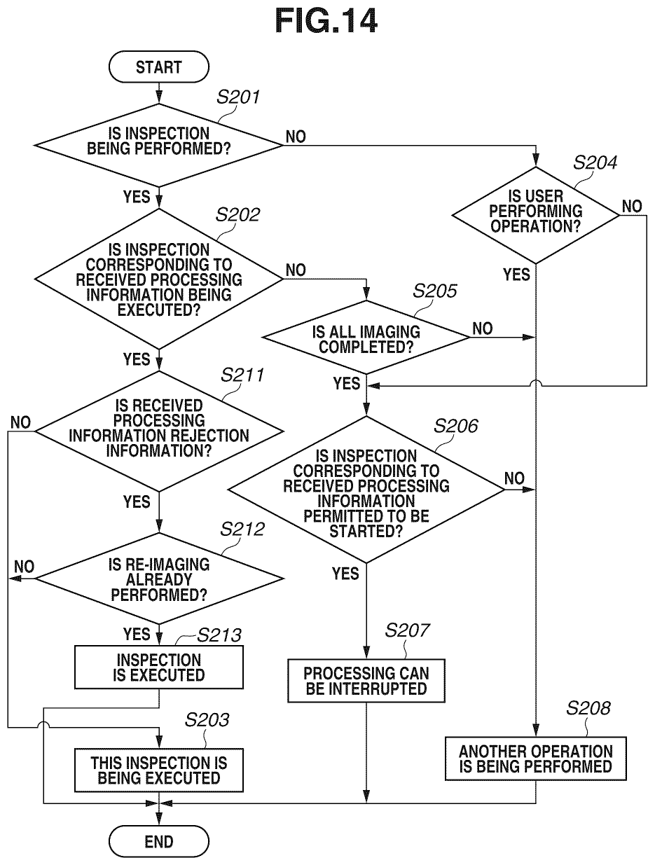

FIG. 14 is a flowchart illustrating an example of a processing procedure in the control method for controlling the radiation imaging apparatus 100 according to the second exemplary embodiment of the present disclosure. Specifically, the flowchart illustrated in FIG. 14 illustrates an example of a processing procedure regarding the determination of the state of the radiation imaging system 10 (more specifically, the radiation imaging apparatus 100) made by the system state determination unit 207 illustrated in FIG. 2. In FIG. 14, processing steps similar to the processing steps illustrated in FIG. 8 are designated by the same step numbers, and are not described in detail.

If the processing of the flowchart illustrated in FIG. 14 is started, the processes of steps S201 and S202 similar to those in FIG. 8 are performed.

If, as a result of the determination in step S202, an inspection including an image associated with the processing information received by the processing information reception unit 211 is being executed (YES in step S202), the processing proceeds to step S211.

In step S211, the system state determination unit 207 determines whether the processing information received by the processing information reception unit 211 is rejection information. If, as a result of this determination, the processing information received by the processing information reception unit 211 is not rejection information (NO in step S211), the processing proceeds to step S203 similar to that in FIG. 8. If, as a result of the determination in step S211, the processing information received by the processing information reception unit 211 is rejection information (YES in step S211), the processing proceeds to step S212.

In step S212, the system state determination unit 207 determines whether the radiation image as the original image corresponding to the rejection information is treated as a rejection and re-imaging is already performed. If, as a result of this determination, re-imaging is not performed (NO in step S212), the processing proceeds to step S203 similar to that in FIG. 8.

If, as a result of the determination in step S212, re-imaging is already performed (YES in step S212), the processing proceeds to step S213.

In step S213, the system state determination unit 207 determines that the state of the radiation imaging apparatus 100 is the state where an inspection is executed. If the process of step S213 is completed, the processing of the flowchart illustrated in FIG. 14 ends.

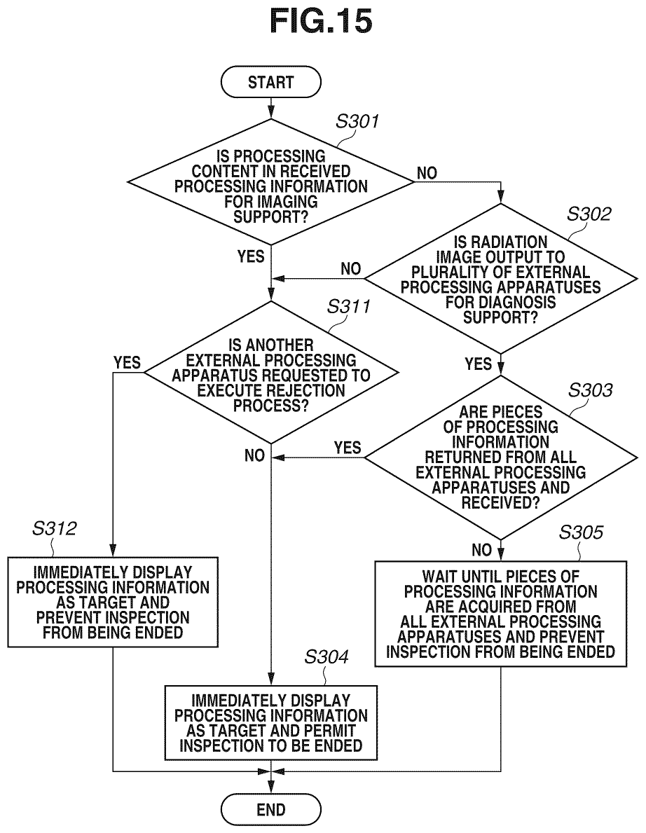

FIG. 15 is a flowchart illustrating an example of a processing procedure in the control method for controlling the radiation imaging apparatus 100 according to the second exemplary embodiment of the present disclosure. Specifically, the flowchart illustrated in FIG. 15 is a flowchart illustrating an example of a processing procedure regarding the display setting of processing information made by the display control unit 221 of the processing information determination unit 220. In FIG. 15, processing steps similar to the processing steps illustrated in FIG. 9 are designated by the same step numbers, and are not described in detail.

If the processing of the flowchart illustrated in FIG. 15 is started, the process of step S301 similar to that in FIG. 9 is performed.

If, as a result of the determination in step S301, the type of the processing content in the processing information received by the processing information reception unit 211 is for imaging support (YES in step S301), the processing proceeds to step S311.

In step S311, the display control unit 221 determines whether another external processing apparatus 800 that executes a rejection process for diagnosis support is requested to execute the rejection process in the same inspection. If, as a result of this determination, another external processing apparatus 800 is not requested to execute the rejection process (NO in step S311), the processing proceeds to step S304 similar to that in FIG. 9.

If, as a result of the determination in step S311, another external processing apparatus 800 is requested to execute the rejection process (YES in step S311), the processing proceeds to step S312.

In step S312, the display control unit 221 performs control to immediately display processing information as a target on the display unit 160, and since the user needs to confirm the rejection process, the display control unit 221 also performs control to prevent the inspection from being ended until the rejection process is all completed. In step S312, since the type of the processing content in the processing information is for imaging support, not for diagnosis support, the processing information as the target is immediately displayed. When the process of step S312 is completed, the processing of the flowchart illustrated in FIG. 15 ends.

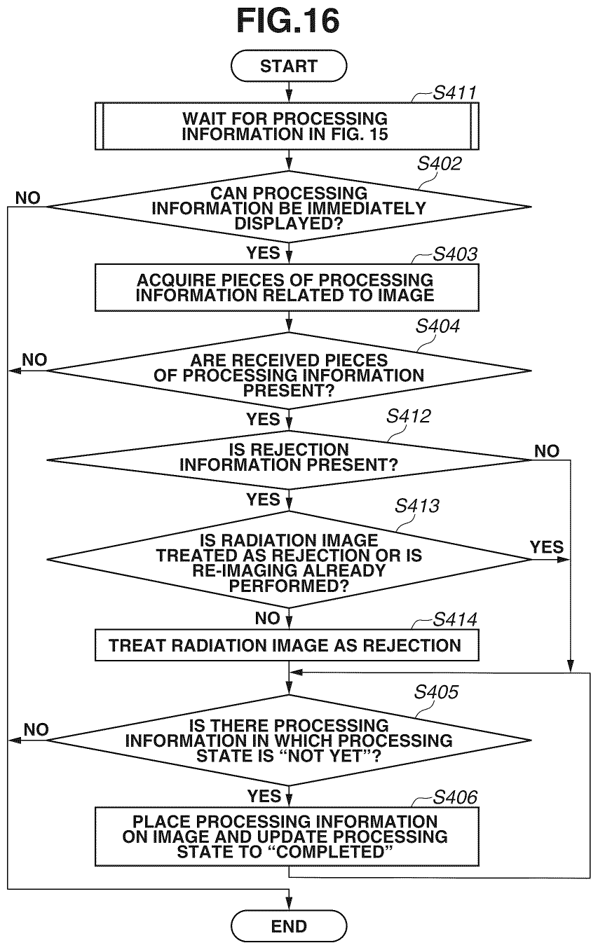

FIG. 16 is a flowchart illustrating an example of a processing procedure in the control method for controlling the radiation imaging apparatus 100 according to the second exemplary embodiment of the present disclosure. Specifically, the flowchart illustrated in FIG. 16 is a flowchart illustrating an example of a processing procedure regarding display control of processing information by the processing information display method control unit 222 of the processing information determination unit 220. The processing information display method control unit 222 performs control when processing information (a radiation image or image-related information) received from an external processing apparatus 800 is displayed on the display unit 160 so that the user can confirm the processing information. FIG. 16 illustrates processing in a case where supplementary information in the processing information is separately present and is rejection information at this time. In FIG. 16, processing steps similar to the processing steps illustrated in FIG. 10 are designated by the same step numbers, and are not described in detail.

If the processing of the flowchart illustrated in FIG. 16 is started, then in step S411, the processing of the flowchart illustrated in FIG. 15 is performed.

When the process of step S411 is completed, the processes of steps S402 to S404 similar to those in FIG. 10 are performed.

If, as a result of the determination in step S404, the received pieces of processing information are present (acquired) (YES in step S404), the processing proceeds to step S412.

In step S412, the processing information display method control unit 222 determines whether rejection information is present in the received pieces of processing information. If, as a result of this determination, rejection information is not present in the received pieces of processing information (NO in step S412), the processing proceeds to step S405 similar to that in FIG. 10.

If, as a result of the determination in step S412, rejection information is present in the received pieces of processing information (YES in step S412), the processing proceeds to step S413.

In step S413, the processing information display method control unit 222 determines whether the radiation image as the original image corresponding to the rejection information is treated as a rejection by the system state determination unit 207 or re-imaging is already performed. If, as a result of this determination, the radiation image as the original image corresponding to the rejection information is treated as a rejection by the system state determination unit 207 or re-imaging is already performed (YES in step S413), the processing proceeds to step S405 similar to that in FIG. 10.

If, as a result of the determination in step S413, the radiation image as the original image corresponding to the rejection information is not treated as a rejection by the system state determination unit 207 or re-imaging is not already performed (NO in step S413), the processing proceeds to step S414.

In step S414, the processing information display method control unit 222 changes the radiation image as the original image corresponding to the rejection information to the radiation image as a rejection. At this time, the reason for the rejection can be automatically set by including the reason for the rejection in the processing information regarding the rejection process. In some cases, a message urging re-imaging can be displayed on the display unit 160. Further, imaging preparations can be automatically made so that re-imaging can be performed.

If the process of step S414 is completed, the processing proceeds to step S405 similar to that in FIG. 10, and the processes of step S405 and the subsequent steps are performed.

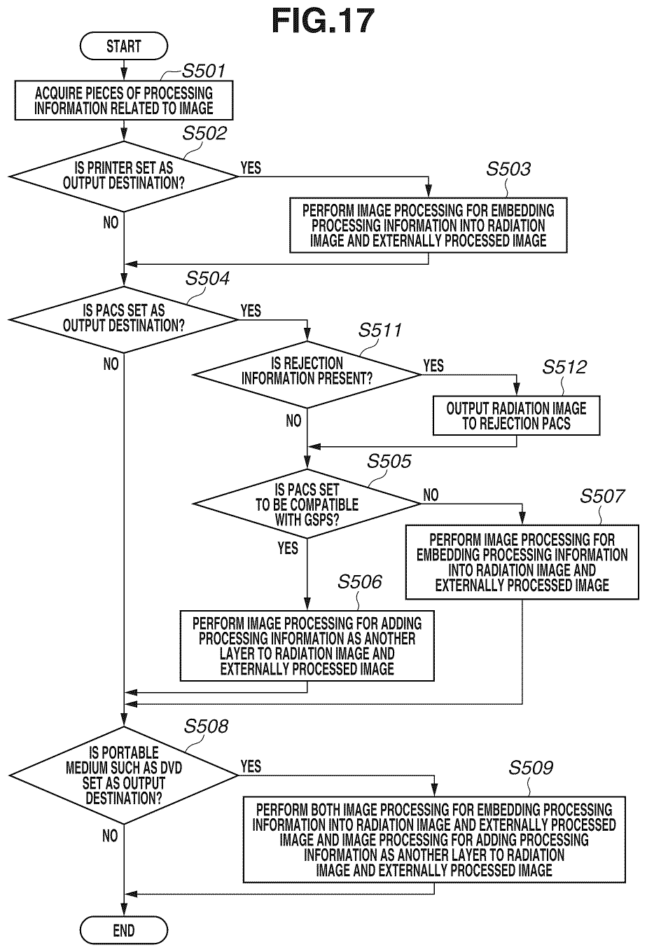

FIG. 17 is a flowchart illustrating an example of a processing procedure in the control method for controlling the radiation imaging apparatus 100 according to the second exemplary embodiment of the present disclosure. Specifically, the flowchart illustrated in FIG. 17 is a flowchart illustrating an example of a processing procedure regarding output control of an image to which processing information is added by the output control unit 223 of the processing information determination unit 220. In FIG. 17, processing steps similar to the processing steps illustrated in FIG. 11 are designated by the same step numbers, and are not described in detail.

If the processing of the flowchart illustrated in FIG. 17 is started, the processes of steps S501 to S504 similar to those in FIG. 11 are performed.

If, as a result of the determination in step S504, the PACS 600 is set as the output destination (YES in step S504), the processing proceeds to step S511.

In step S511, the output control unit 223 determines whether rejection information is present in the processing information acquired in step S501. If, as a result of this determination, rejection information is not present in the processing information acquired in step S501 (NO in step S511), the processing proceeds to step S505 similar to that in FIG. 11.

If, as a result of the determination in step S511, rejection information is present in the processing information acquired in step S501 (YES in step S511), the processing proceeds to step S512.

In step S512, the output control unit 223 performs control to additionally automatically output the radiation image as the original image in which a rejection is detected by an external processing apparatus 800 to the rejection PACS 600 as the image saving apparatus that saves rejection images. Such an output is provided, whereby the radiation image can be automatically reflected on an inspection in the radiation imaging apparatus 100 after an external processing apparatus 800 detects a rejection (a failure) in a radiation image. Further, the radiation image is also automatically output to the rejection PACS 600, it is therefore possible to reduce an operation of the user.

When the process of step S512 is completed, the processing proceeds to step S505 similar to that in FIG. 11, and the processes of step S505 and the subsequent steps are performed.

According to the second exemplary embodiment, the user can efficiently perform the work of confirming processing information obtained as a result of an external processing apparatus 800 processing a radiation image, similarly to the first exemplary embodiment.

For example, in a case where a plurality of external processing apparatuses perform processing, or in a case where many externally processed images are handled, useful information is provided to a user such as a doctor or a technologist, whereas processing information (which can include an externally processed image) to be confirmed by the user increases. In this case, for example, it is inefficient that every time processing information is acquired, the user performs the work of confirming the processing information. Accordingly, the present disclosure is directed to providing a mechanism in which a user can efficiently perform the work of confirming processing information obtained as a result of an external processing apparatus processing a radiation image. An information processing apparatus according to the present disclosure includes an acquisition unit configured to acquire processing information obtained by an external processing apparatus processing a radiation image from the external processing apparatus. The information processing apparatus according to the present disclosure also includes a control unit configured to perform control to, according to a type of a processing content in the processing information, determine whether to immediately display the processing information on a display unit or to display the plurality of pieces of processing information on the display unit after the acquisition unit acquires a plurality of the pieces of processing information in which the processing content is of the same type. Based on this, a user can efficiently perform the work of, for example, confirming processing information obtained as a result of an external processing apparatus processing a radiation image. The present disclosure includes an embodiment in which a configuration including the overall control unit 120, the radiation generating apparatus control unit 130, the operation unit 140, and the display control unit 150 except for the radiation detection unit 110 in the configuration of the radiation imaging apparatus 100 illustrated in FIG. 1 is an “information processing apparatus”.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-201194, filed Dec. 16, 2022, which is hereby incorporated by reference herein in its entirety.

What is claimed is:

1. An information processing apparatus comprising:
an obtaining unit configured to obtain processing information obtained by an external processing apparatus processing a radiation image from the external processing apparatus; and
a control unit configured to perform control to, according to a type of a processing content in the processing information, determine whether to immediately display the processing information on a display unit, or after the obtaining unit obtains a plurality of pieces of the processing information in which the processing content is of a same type, display the plurality of pieces of the processing information on the display unit.

2. The information processing apparatus according to claim 1, wherein, in a case where the processing content is for imaging support, the control unit performs control to immediately display the processing information on the display unit.

3. The information processing apparatus according to claim 1, wherein, in a case where the processing content is for diagnosis support, the control unit performs control to, after the obtaining unit obtains the plurality of pieces of the processing information in which the processing content is for the diagnosis support, display the plurality of pieces of the processing information on the display unit.

4. The information processing apparatus according to claim 3, wherein, in a case where the obtaining unit already obtains the plurality of pieces of the processing information in which the processing content is for the diagnosis support, the control unit performs control to immediately display the plurality of pieces of the processing information on the display unit.

5. The information processing apparatus according to claim 3, wherein, in a case where there is not the plurality of pieces of the processing information in which the processing content is for the diagnosis support, the control unit performs control to immediately display the processing information on the display unit.

6. The information processing apparatus according to claim 1,
wherein, in a case where the control unit performs control to immediately display the processing information on the display unit, the control unit performs control to permit an inspection including the radiation image to be ended, and
wherein, in a case where the control unit performs control to display the plurality of pieces of the processing information on the display unit, the control unit performs control to prevent the inspection from being ended until the obtaining unit obtains the plurality of pieces of the processing information in which the processing content is of the same type.

7. The information processing apparatus according to claim 1,
wherein, in a case where the processing content in the processing information is for imaging support, and in a case where a rejection process is requested in an inspection including the radiation image, the control unit performs control to immediately display the processing information on the display unit and performs control to prevent the inspection from being ended, and
wherein in, a case where the processing content in the processing information is for the imaging support, and in a case where the rejection process is not requested in the inspection, the control unit performs control to immediately display the processing information on the display unit and performs control to permit the inspection to be ended.

8. The information processing apparatus according to claim 1, wherein, in a state where an inspection including the radiation image is being performed or in a state where the inspection is started, the control unit performs control to display the processing information on the display unit.

9. The information processing apparatus according to claim 1, wherein, in a case where the control unit performs control to display the processing information on the display unit, the control unit performs display control for placing the processing information on the radiation image.

10. The information processing apparatus according to claim 1,
wherein the obtaining unit obtains the plurality of pieces of the processing information, and at least one piece of processing information of the plurality of pieces of the processing information includes an externally processed image obtained by the external processing apparatus processing the radiation image, and
wherein, in a case where the control unit performs control to display the processing information on the display unit, the control unit performs display control for placing the processing information on at least one image of the radiation image and the externally processed image.

11. The information processing apparatus according to claim 10, wherein the control unit performs control to output an output image obtained by adding the processing information to the at least one image to an output destination different from the external processing apparatus.

12. The information processing apparatus according to claim 11, wherein the output image is obtained by adding the processing information to the at least one image by embedding the processing information into the at least one image or obtained by adding the processing information as another layer to the at least one image.

13. The information processing apparatus according to claim 1, wherein, in a case where the processing information includes rejection information, the control unit performs control to make a setting for treating the radiation image as a rejection, and output the radiation image to an image saving apparatus configured to save a rejection image.

14. The information processing apparatus according to claim 1, wherein the processing information includes at least one piece of information among information regarding an externally processed image obtained by the external processing apparatus processing the radiation image, overlay information, report information, and rejection information.

15. A radiation imaging system comprising:
a detection unit configured to detect radiation; and
the information processing apparatus according to claim 1 communicably connected to the detection unit and communicably connected to the external processing apparatus.

16. An information processing method comprising:
obtaining processing information obtained by an external processing apparatus processing a radiation image from the external processing apparatus; and
performing control to, according to a type of a processing content in the processing information, display the processing information on a display unit at different times.

17. A non-transitory computer-readable storage medium storing a program for causing a computer to execute the method according to claim 16.

18. An information processing apparatus comprising:
an obtaining unit configured to obtain processing information obtained by an external processing apparatus processing a radiation image from the external processing apparatus; and
a control unit configured to perform control to, according to a type of a processing content in the processing information, display the processing information on a display unit at different times.
